(19) United States
(12) Patent Application Publication
(10) Pub. No.: US 2025/0018689 A1
(43) Pub. Date: Jan. 16, 2025

(54) POLYMER INTERLAYERS WITH IMPROVED ACOUSTIC PROPERTIES

(71) Applicant: SOLUTIA INC., ST. LOUIS, MO (US)

(72) Inventors: YINONG MA, LONGMEADOW, MA (US); GUANGXIN TANG, SAN JOSE, CA (US); WENJIE CHEN, AMHERST, MA (US)

(73) Assignee: SOLUTIA INC., ST. LOUIS, MO (US)

(21) Appl. No.: 18/687,453

(22) PCT Filed: Oct. 5, 2022
(86) PCT No.: PCT/US2022/045766

§ 371 Date: Feb. 28, 2024

Related U.S. Application Data
(60) Provisional application No. 63/298,253, filed on Jan. 11, 2022.
(60) Provisional application No. 63/253,779, filed on Oct. 8, 2021.

(51) Int. Cl. B32B 17/10; B32B 27/22

(52) U.S. Cl. CPC B32B 17/10761; B32B 17/10036; B32B 17/10568; B32B 17/10605; B32B 27/22; B32B 2250/05; B32B 2270/00; B32B 2307/102; B32B 2307/51; B32B 2307/56

(57) ABSTRACT

A polymer interlayer with improved acoustic properties. The polymer interlayer comprises a first polymer layer, a second polymer layer, and a third polymer layer. The first polymer layer is positioned between the second polymer layer and the third polymer layer. The first polymer layer is formed from a resin comprising polyvinyl acetate (PVAc). The first polymer layer has a Tg of less than about 20° C. and a peak tan δ greater than about 2.0.

### FIELD OF THE INVENTION

The present invention is related to the field of polymer interlayers and multiple layer panels comprising polymer interlayers. More specifically, the present invention is related to the field of polymer interlayers comprising multiple polymer layers and the manufacturing and use thereof.

### DESCRIPTION OF RELATED ART

Multiple layer panels are panels comprised of two sheets of a substrate (such as, but not limited to, glass, polyester, polyacrylate, or polycarbonate) with one or more polymer interlayers sandwiched therebetween. Laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces.

Additionally, the interlayer may also give the glass a preferential sound insulation rating, reduce UV and/or IR light transmission, and enhance the aesthetic appeal of the associated window. For example, laminated glass panels with desirable acoustic properties have been produced, resulting in quieter internal spaces. Furthermore, laminated glass panels been used in vehicles equipped with heads-up display (“HUD”) systems (also referred to as head-up systems), which project an image of an instrument cluster or other important information to a location on the windshield at the eye level of the vehicle operator. Such a display allows the driver to stay focused on the upcoming path of travel while visually accessing dashboard information.

Generally, the HUD system in an automobile or an aircraft uses the inner surface of the vehicle windscreen to partially reflect the projected image. However, there is a secondary reflection taking place at the outside surface of the vehicle windscreen that forms a weak secondary image or “ghost” image. Since these two reflective images are offset in position, double images are often observed, which cause an undesirable viewing experience to the driver. When the image is projected onto a windshield which has a uniform and consistent thickness, the interfering double, or reflected ghost, image is created due to the differences in the position of the projected image as it is reflected off the inside and outside surfaces of the glass. One method of addressing these double or ghost images is to orient the inner and outer glass sheets at an angle from one another. This aligns the position of the reflected images to a single point, thereby creating a single image. Typically, this is done by displacing the outer sheet relative to the inner sheet by employing a wedge-shaped, or “tapered,” interlayer that includes at least one region of nonuniform thickness. Many conventional tapered interlayers include a constant wedge angle over the entire HUD region, although some interlayers have recently been developed that include multiple wedge angles over the HUD region.

In order to achieve the required property and performance characteristics for glass panels (e.g., sound insulation, light transmission, HUD display, and/or enhance the aesthetic appeal), it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. As noted above, interlayers with one soft “core” layer sandwiched between two more rigid or stiff “skin” layers have been designed with sound insulation properties for the glass panel. Such a configuration is generally referred to herein as a “trilayer” interlayer. The soft “core” layer is considered an acoustic layer (as the soft layer beneficially reduces sound transmission), while the stiff “skin” layers are referred to as conventional layer, or non-acoustic layers.

Commonly, the layers of the interlayer are produced by mixing a polymer resin, such as poly(vinyl butyral), with one or more plasticizers and melt processing the mix into a sheet by any applicable process or method known to one of skill in the art, including, but not limited to, extrusion, with the layers being combined by processes such as co-extrusion and lamination. In a trilayer interlayer, the core layer may include more plasticizer than the skin layers, such that the core layer is softer than relatively harder skin layers. Other additional ingredients, as described in more detail below, may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, a multiple layer interlayer may be coextruded using a multiple manifold coextrusion device. The device operates by simultaneously extruding polymer melts from each manifold toward an extrusion opening. Properties of the layers can be varied by adjusting attributes (e.g., temperature and/or opening dimensions) of the die lips at the extrusion opening. Once formed, the interlayer sheet can be placed between two glass substrates and any excess interlayer is trimmed from the edges, creating an assembly. It is not uncommon for multiple polymer interlayer sheets or a polymer interlayer sheet with multiple layers (or a combination of both) to be placed within the two glass substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

In view of the above, there remains a need in the art for the development of a multilayered interlayer that provides enhanced acoustic characteristics without a reduction in other optical or mechanical properties of a conventional multilayered interlayer. More specifically, there is a need in the art for the development of multilayered interlayers having at least one soft core layer and one stiff skin layer that provides enhanced acoustic properties. Furthermore, there is a need for the polymer layers of such multilayer interlayers to exhibit suitable compatibility with each other so to provide for adequate adhesion to facilitate bonding of the polymer layers during manufacturing and use of the interlayers.

### BRIEF DESCRIPTION OF THE DRAWINGS

FIG. 1 is a schematic illustration of a laminated glass panel comprising a pair of glass plates opposing a polymer interlayer, with the polymer interlayer comprising a trilayer with a pair of skin layers opposing a core layer;

FIG. 2 is another schematic illustration of a laminated glass panel comprising a pair of glass plates opposing a polymer interlayer, with the polymer interlayer having a wedge shape; and

FIG. 3 is graphical plot of tan δ values for two different polymer interlayer sheets, with one of the polymer interlayer sheets comprising polyvinyl acetate (PVAc) with a glycerin based plasticizer and another of the polymer interlayer sheets comprising poly (vinyl butyral) (PVB);

FIG. 4 is graphical plot of tan δ values for three different polymer interlayer sheets, with two of the polymer interlayer sheets comprising polyvinyl acetate (PVAc) with ethylene glycol diester plasticizers and another of the polymer interlayer sheets comprising poly (vinyl butyral) (PVB);

FIG. 5 is a schematic illustration of a two-dimensional sound transmission loss model for simulating sound transmission loss for a laminated glass panel;

FIG. 6 is a graphical plot of simulated sound transmission loss for two glass panels including the polymer interlayers from FIG. 4, with the sound transmission loss obtained using the sound transmission loss model from FIG. 5;

FIG. 7 is graphical plot of tan δ values for four different polymer interlayer sheets, with three of the polymer interlayer sheets comprising polyvinyl acetate (PVAc) with varying amounts of ethylene glycol diester plasticizers and another of the polymer interlayer sheets comprising poly (vinyl butyral) (PVB);

FIG. 8 is a graphical plot of simulated sound transmission loss for three glass panels including the polymer interlayers from FIG. 7, with the sound transmission loss obtained using the sound transmission loss model from FIG. 5;

FIG. 9 is graphical plot of tan δ values for three different polymer interlayer sheets, with two of the polymer interlayer sheets comprising hybrid polyvinyl acetate (PVAc) and another of the polymer interlayer sheets comprising poly (vinyl butyral) (PVB);

FIG. 10 is graphical plot of tan δ values for two different trilayer polymer interlayers, with one of the polymer interlayers having a core layer comprising hybrid polyvinyl acetate (PVAc) and the other polymer interlayer having a core layer comprising poly (vinyl butyral) (PVB);

FIG. 11 is graphical plot of tan δ values for two different trilayer polymer interlayers, with each of the polymer interlayers having a core layer comprising hybrid polyvinyl acetate (PVAc);

FIG. 12 is a graphical plot of simulated sound transmission losses for three laminated glass panels each having a trilayer polymer interlayer, with two of the polymer interlayers having a core layer comprising hybrid polyvinyl acetate (PVAc) and the other polymer interlayer having a core layer comprising poly (vinyl butyral) (PVB), and with the sound transmission loss obtained using the sound transmission loss model from FIG. 5;

FIG. 13 is a graphical plot of differences between the simulated sound transmission losses from FIG. 12;

FIG. 14 is another graphical plot of simulated sound transmission losses for three laminated glass panels each having a trilayer polymer interlayer, with two of the polymer interlayers having a core layer comprising hybrid polyvinyl acetate (PVAc) and the other polymer interlayer having a core layer comprising poly (vinyl butyral) (PVB), and with the sound transmission loss obtained using the sound transmission loss model from FIG. 5;

FIG. 15 is a graphical plot of differences between the sound transmission losses from FIG. 14; and

FIG. 16 is graphical plot of tan δ values for two different polymer interlayers, with one of the polymer interlayers being a trilayer having a core layer comprising poly (vinyl butyral) (PVB) and with the other polymer interlayer being a five-layer interlayer with a core layer comprising polyvinyl acetate (PVAc), bonding layers comprising hybrid polyvinyl acetate (PVAc), and the skin layers comprising poly (vinyl butyral) (PVB).

### SUMMARY

One aspect of the present invention concerns a polymer interlayer with improved acoustic properties. The polymer interlayer comprises a first polymer layer, a second polymer layer, and a third polymer layer. The first polymer layer is positioned between the second polymer layer and the third polymer layer. The first polymer layer is formed from a resin comprising polyvinyl acetate (PVAc). The first polymer layer has a T_{g} of less than about 20° C. and a peak tan δ greater than about 2.0.

An additional aspect of the present invention concerns a method of forming a polymer interlayer that with improved acoustic properties. The method comprises a step of extruding a first polymer melt to form a first polymer layer. An additional step includes extruding a second polymer melt to form a second polymer layer and a third polymer layer. Upon the extruding steps, the first polymer layer is positioned between the second and third polymer layers. The first polymer layer is formed from a resin comprising polyvinyl acetate (PVAc). The first polymer layer has a T_{g} of less than about 20° C. and a peak tan δ greater than about 2.0.

An additional aspect of the present invention concerns a polymer interlayer comprising a first polymer layer, a second polymer layer, and a third polymer layer. The first polymer layer is positioned between the second polymer layer and the third polymer layer. The first polymer layer is formed from a resin comprising hybrid polyvinyl acetate (PVAc). The first polymer layer has a T_{g} of less than about 20° C. and a peak tan δ greater than about 1.5.

A further aspect of the present invention concerns a polymer interlayer comprising a first polymer layer, a second polymer layer, and a third polymer layer. The first polymer layer is positioned between the second polymer layer and the third polymer layer. The first polymer layer is formed from a resin comprising polyvinyl acetate (PVAc). The polymer interlayer has a T_{g} of less than about 20° C. and a peak tan δ greater than about 1.3.

### DETAILED DESCRIPTION

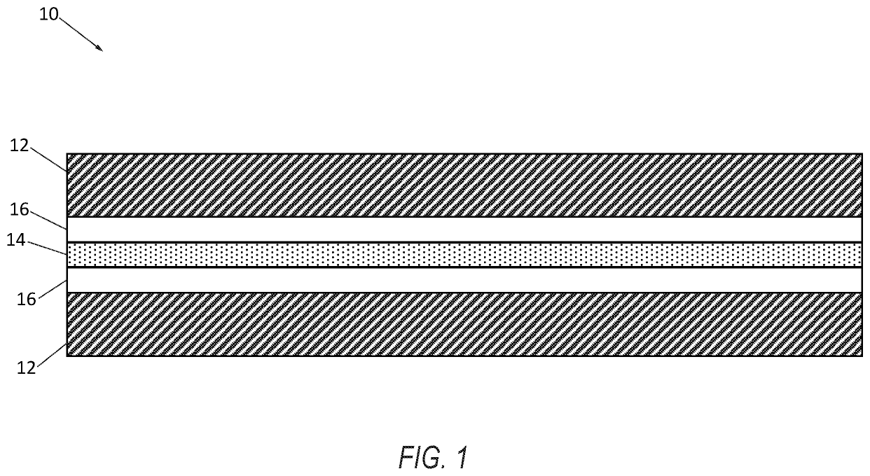

Embodiments of the present invention are directed to multiple layer panels and methods of making multiple layer panels. Generally, multiple layer panels are comprised of two sheets of glass, or other applicable substrates, with a polymer interlayer sheet or sheets sandwiched there-between. Multiple layer panels are generally produced by placing at least one polymer interlayer sheet between two substrates to create an assembly. FIG. 1 illustrates a multiple layer panel 10 comprising a pair of glass sheets 12 with a multilayered interlayer sandwiched therebetween. The multilayered interlayer is configured as a trilayer interlayer having three individual polymer interlayer sheets, including a soft core layer 14 and two relatively stiffer skin layers 16 positioned on either side of the core layer 14. In some additional embodiments of the present invention, however, the multilayered interlayer may comprise more than three individual layers. For example, in certain embodiments, the multilayered interlayer may comprise a five-layer interlayer with a bonding layer positioned between the core layer 14 and each of the skin layers 16.

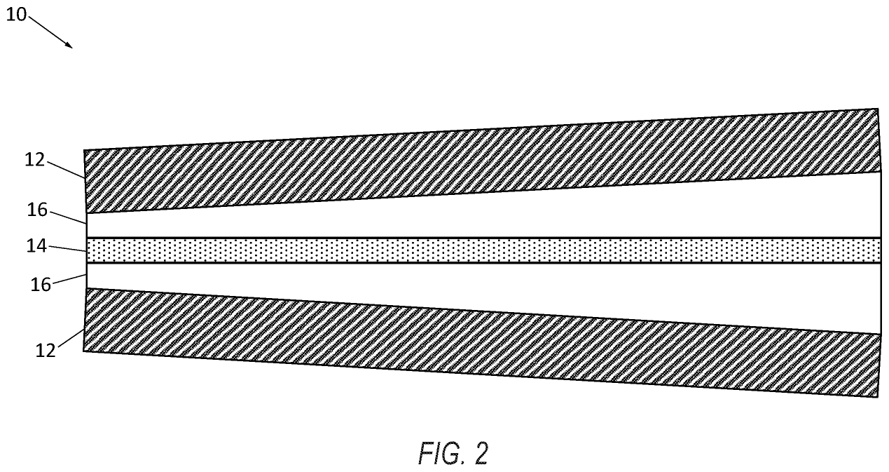

In some embodiments, the interlayer (e.g., the core layer 14 and the skin layers 16) will have a generally constant or uniform thickness about the length of the interlayer. However, in alternative embodiments, as shown in FIG. 2, the interlayer may have at least one region of non-uniform thickness. For example, the interlayer, comprised of the core layer 14 and skin layers 16, may be wedge-shaped, such that the thickness of the interlayer changes (e.g., linearly) about the length of the interlayer. In some such embodiments, the thickness of the interlayer may change due to a thickness change in the core layer 14 (i.e., with the skin layers 16 having a generally constant thickness). Alternatively, the thickness of the interlayer may change due to a thickness change in the skin layers 16 (i.e., with the core layer 14 having a generally constant thickness). In further alternatives, the thickness of the interlayer may change due to a thickness change in both the core layer 14 and the skin layers 16.

In order to facilitate a more comprehensive understanding of the interlayers and multiple layer panels disclosed herein, the meaning of certain terms, as used in this application, will be defined. These definitions should not be taken to limit these terms as they are understood by one of ordinary skill, but simply to provide for improved understanding of how certain terms are used herein.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises a polymer resin. The term “resin,” as utilized herein refers to the polymeric component (e.g., PVAc or PVB) removed from the mixture that results from the acid catalysis and subsequent neutralization of polymeric precursors. Generally, plasticizer, such as those discussed more fully below, is added to the resins to result in a plasticized polymer. Additionally, resins may have other components in addition to the polymer and plasticizer including; e.g., acetates, salts and alcohols.

It should be understood that various thermoplastic interlayers may be used as the polymer resin of the polymer interlayers. Contemplated polymers include, but are not limited to, polyurethane, polyvinyl chloride, polyvinyl acetate (“PVAc”), poly (vinyl butyral) (“PVB”) and combinations thereof. These polymers can be utilized alone, or in combination with other polymers. Accordingly, it should be understood that when ranges, values and/or methods are given for a given polymer interlayer in this application (e.g., plasticizer component percentages, thickness and characteristic-enhancing additives), those ranges, values and/or methods may also apply, where applicable, to the other polymers and polymer blends disclosed herein or could be modified, as would be known to one of ordinary skill, to be applied to different materials. As used herein, the term “molecular weight” refers to weight average molecular weight (Mw). The molecular weight of PVAc or PVB resins disclosed herein can be in the range, for example. of from about 50,000 to about 600,000, about 70,000 to about 450,000, or about 100,000 to about 425,000 Daltons. In certain preferred embodiments, the molecular weight of the PVAc resin can be in the range of from about 100,000 to about 1,500,000 or from about 200,000 to about 700,000 Daltons, or about 500,000 Daltons.

When the resin compositions, layers, and interlayers described herein include PVAc resins, the PVAc can be formed according to any suitable method, and may comprise, in addition to the desired percent acetate functionality, residual hydroxyl content, and optionally aldehyde content such as butyraldehyde. For example, the PVAc resins of the invention may be formed by free radical polymerization of vinyl acetate monomer, to form PVAc homopolymer in which the acetate content is substantially 100 wt. % acetate. With subsequent hydrolysis, a lower desired percent acetate with residual hydroxyl content may be obtained. If the free radical polymerization is carried out in the presence of ethylene or another copolymer, the polyvinyl acetate residue is present in the polymer in an amount of at least 80 wt. %, or at least 90 wt. %, or at least 95 wt. %, or at least 98 wt. %. Thus, the PVAc described herein may comprise at least 80 wt. %, or at least 90 wt. %, or at least 95 wt. %, or at least 98 wt. % acetate.

Alternatively, a hybrid-form of PVAc may be formed by acetalization of PVAc, optionally partially hydrolyzed (having residual hydroxyl content), in the presence of one or more aldehydes, with use of an acid catalyst. When the acetalization is carried out in the presence of an aldehyde such as butyraldehyde, residual aldehyde groups will be present, in addition to the acetate and hydroxyl content. For example, the aldehyde content of the PVAc may comprise one or more of acetaldehyde, propionaldehyde, isobutyraldehyde or n-butyraldehyde. As such, the aldehyde content of the PVAc may be from 4 to 45 wt. %, from 4 to 40 wt. %, from 4 to 35 wt. %, from 4 to 30 wt. %, from 4 to 25 wt. %, from 4 to 20 wt. %, from 4 to 15 wt. %, from 4 to 10 wt. %, 5 to 45 wt. %, from 5 to 40 wt. %, from 5 to 35 wt. %, from 5 to 30 wt. %, from 5 to 25 wt. %, from 5 to 20 wt. %, from 5 to 15 wt. %, from 5 to 10 wt. %, 10 to 45 wt. %, from 10 to 40 wt. %, from 10 to 35 wt. %, from 10 to 30 wt. %, from 10 to 25 wt. %, from 10 to 20 wt. %, from 10 to 15 wt. %, 15 to 45 wt. %, from 15 to 40 wt. %, from 15 to 35 wt. %, from 15 to 30 wt. %, from 15 to 25 wt. %, from 15 to 20 wt. %, from 20 to 45 wt. %, from 20 to 40 wt. %, from 20 to 35 wt. %, from 20 to 30 wt. %, from 20 to 25 wt. %, from 30 to 45 wt. %, from 30 to 40 wt. %, from 30 to 35 wt. %, from 40 to 45 wt. %, and/or up to about 45 wt. %, or up to 40 wt. %, or up to 35 wt. %, or up to 30 wt. %, or up to 25 wt. %, or up to 20 wt. %, or up to 15 wt. %, or up to 10 wt. %. In addition, the residual hydroxyl content of the PVAc of the invention may be, for example, from about 4 to about 30 wt. %, or from 4 to about 25 wt. %, or from 4 to 20 wt. %, or from 4 to 15 wt. %, or from 4 to 10 wt. %, or from about 5 to about 30 wt. %, or from 5 to about 25 wt. %, or from 5 to 20 wt. %, or from 5 to 15 wt. %, or from 5 to 10 wt. %, or from 10 to 25 wt. %, or from 10 to 20 wt. %, or from 10 to 15 wt. %, or from 15 to 25 wt. %, or from 15 to 20 wt. %, and/or up to about 30 wt. %, or up to 25 wt. %, or up to 20 wt. %, or up to 15 wt. %, or up to 10 wt. %, or up to 5 wt. %.

The resulting PVAc according to the invention may have a total percent acetate content of at least about 40 wt. %, at least 45 wt. % or at least about 50 wt. %. Alternatively, the percent acetate may be at least about 55 wt. %, or at least about 60 wt. %, or at least about 65 wt. %, or at least about 70 wt. %, or at least about 75 wt. %, at least 80 wt. %, at least 85 wt. %, at least 90 wt. %, at least 95 wt. %, up to 100 wt. %, and/or from 40 to 100 wt. %, from 40 to 90 wt. %, from 40 to 80 wt. %, from 40 to 70 wt. %, from 40 to 60 wt. %, from 40 to 50 wt. %, from 50 to 100 wt. %, from 50 to 90 wt. %, from 50 to 80 wt. %, from 50 to 70 wt. %, from 50 to 60 wt. %, from 60 to 100 wt. %, from 60 to 90 wt. %, from 60 to 80 wt. %, from 60 to 70 wt. %, from 70 to 100 wt. %, from 70 to 90 wt. %, from 70 to 80 wt. %, from 80 to 100 wt. %, from 80 to 90 wt. %, or from 90 to 100 wt. % as measured according to ASTM D-1396, unless otherwise noted. The total amount of any aldehyde residues in a PVAc resin can be collectively referred to as the acetal component, with the balance of the PVAc resin being residual hydroxyl and residual acetate groups, which will be discussed in further detail below.

It should be understood that the PVAc resin of embodiments of the present invention may comprise any combination of the compositional values (or range of values) described above. For example, in some embodiments, the PVAc may comprise from 40 to 80 wt. % acetate content, from 5 to 20 wt. % hydroxyl content, and from 10 to 45 wt. % aldehyde content. In certain specific embodiments, the PVAc may comprise from 50 to 70 wt. % acetate content, from 10 to 15 wt. % hydroxyl content, and from 25 to 35 wt. % aldehyde content. In some further specific embodiments, the PVAc may comprise about 60 wt. % acetate content, about 10 wt. % hydroxyl content, and about 30 wt. % aldehyde content. In still further specific embodiments, the PVAc may comprise about 50 wt. % acetate content, about 15 wt. % hydroxyl content, and about 35 wt. % aldehyde content. The term “hybrid” may be used herein with respect to a PVAc resin (or resulting polymer layer) when the resin has at least 40 wt. % acetate content in addition to non-nominal hydroxyl and aldehyde contents (e.g., more than about 4 wt. % of hydroxyl and/or aldehyde contents). However, the general term “PVAc” may be used herein to refer to either hybrid PVAc resins or resins consisting essentially of polyvinyl acetate.

The resin forming the compositions, layers, and interlayers described herein may be produced by known processes, such as for example, those described in Solvent-Free Generation of Poly(Viny Acetals) Directly from Poly(Vinyl Acetate), in Polymer Engineering and Science, Volume 39, Issue 5, pages 862-871, by O'Neill, Mark L. (2004), the entire disclosure of which is incorporated herein by reference.

While generally referred herein as “poly(vinyl acetal)” or “poly(vinyl butyral)”, the resins described herein may include residues of any suitable aldehyde, including, but not limited to, isobutyraldehyde, as previously discussed. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers function by embedding themselves between chains of polymers, spacing them apart (increasing the “free volume”) and thus significantly lowering the glass transition temperature (T_{g}) of the polymer resin, making the material softer. In this regard, the amount of plasticizer in the interlayer can be adjusted to affect the glass transition temperature T_{g}. The glass transition temperature T_{g} is the temperature that marks the transition from the glassy state of the interlayer to the rubbery state. In general, higher amounts of plasticizer loading can result in lower T_{g}. In some embodiments, such as when the interlayer is an acoustic trilayer, the inner core layer (i.e., the soft layer) will have a glass transition temperature less than about 20° C., while the outer skin layers (e.g., the stiff layer) will have a glass transition temperature greater than about 25° C. More broadly, the inner core layer (i.e., the soft layer) may be softer than the outer skin layers (e.g., the stiff layer).

Contemplated plasticizers include, but are not limited to, glycerin based, ethylene glycol diester plasticizers, and/or combinations thereof. For instance, glycerin based plasticizers may include tributyrin. Ethylene glycol diester plasticizers may include, for instance, diesters with four or more repeating units of ethylene glycol. For example, the ethylene glycol diester plasticizers may include tetraethylene glycol di-(2-ethylhexanoate) (“4-GEH”), which includes ethylene glycol diester molecules with four repeating units of ethylene glycol. In addition, the ethylene glycol diester plasticizers may include polyethylene glycol bis-(2-ethylhexanoate), which includes ethylene glycol diester molecules with ten repeating units of ethylene glycol.

In some embodiments, the glycerin based and/or ethylene glycol diester plasticizers may include molecules with specific oxygen to carbon ratios. Such configurations may facilitate preferred solubility characteristics of the plasticizers. For example, in some embodiments, the oxygen to carbon ratio of the glycerin based and/or ethylene glycol diester plasticizers may be at least 0.32, at least 0.34, at least 0.36, at least 0.38, at least 0.40, at least 0.42, at least 0.44, at least 0.46, at least 0.48, or at least 0.50. In some embodiments, the oxygen to carbon ratio of the glycerin based and/or ethylene glycol diester plasticizers may be from 0.32 to 0.50, from 0.32 to 0.44, from 0.32 to 0.40, from 0.34 to 0.50, from 0.34 to 0.44, from 0.34 to 0.40, from 0.36 to 0.50, from 0.36 to 0.44, and/or from 0.36 to 0.40.

Furthermore, in some embodiments, the glycerin based and/or ethylene glycol diester plasticizers may comprise preferred solubility attributes. In more detail, the total solubility parameter δₜₒₜ of material may be defined based on the Hansen solubility parameter of the material. The total solubility parameter δₜₒₜ may be comprised of solubility contributions from δ_{d}, δₚ, δₕ, which

are parameters representing solubility contributions from dispersion, polar, and hydrogen bonding interactions, respectively. The δₜₒₜ of a material may be calculated by the following equation (1):

$${δ}_{tot}^{2} = {δ}_{d}^{2} + {δ}_{p}^{2} + {δ}_{h}^{2} \qquad ( 1 )$$

In some embodiments, the polar solubility contribution δₚ of the total solubility parameter δₜₒₜ of the glycerin based and/or ethylene glycol diester plasticizers may be at least 3.7, at least 3.8, at least 3.9, at least 4.0, at least 4.4, at least 4.8, at least 5.0, at least 5.4, at least 5.8, at least 6.0, at least 6.4, at least 6.8, and/or at least 7.0. Units of the solubility parameters are provided in MPa^{1/2}. In some embodiments, the polar solubility contribution δₚ of the total solubility parameter δₜₒₜ of the glycerin based and/or ethylene glycol diester plasticizers may be from 3.7 to 7.0, from 3.8 to 6.0, and/or from 3.8 to 6.0. In some embodiments, the hydrogen bonding solubility contribution δₕ of the total solubility parameter δₜₒₜ of the glycerin based and/or ethylene glycol diester plasticizers may be at least 4.6, at least 4.7, at least 4.8, at least 5.0, at least 5.2, at least 5.4, at least 5.6, at least 5.8, at least 6.0, at least 6.2, at least 6.4, at least 6.6, at least 6.8, at least 7.0, at least 7.2, at least 7.4, at least 7.6, at least 7.8, at least 8.0. In some embodiments, the polar solubility contribution δₕ of the total solubility parameter δₜₒₜ of the glycerin based and/or ethylene glycol diester plasticizers may be from 4.6 to 8.0, from 4.6 to 7.0, from 4.8 to 8.0, from 4.8 to 7.0, from 5.4 to 8.0, and/or from 5.4 to 7.0.

Furthermore, a polar/hydrogen solubility parameter δ_{(p,h)} for a material may be comprised of solubility contributions from only δₚ and δₕ, which are parameters representing solubility contributions from polar and hydrogen bonding interactions, respectively. The δ_{(p,h)} of a material may be calculated by the following equation (2):

$${δ}_{( p , h )}^{2} = {δ}_{p}^{2} + {δ}_{h}^{2} \qquad ( 2 )$$

In some embodiments, the polar/hydrogen solubility parameter δ_{(p,h)} of the glycerin based and/or ethylene glycol diester plasticizers may be at least 5.8, at least 6.0, at least 6.2, at least 6.5, at least 7.0, at least 7.5, at least 8.0, at least 8.5, and/or at least 9.0. In some embodiments, the polar/hydrogen solubility parameter δ_{(p,h)} of the glycerin based and/or ethylene glycol diester plasticizers may be from 5.8 to 9.0, from 6.0 to 9.0, and/or from 7.0 to 9.0. In some embodiments, a ratio of the polar/hydrogen solubility parameter δ_{(p,h)} to the total solubility parameter δₜₒₜ of the glycerin based and/or ethylene glycol diester plasticizers (i.e., δ_{(p,h)}/δₜₒₜ) may be at least 0.365, at least 0.375, at least 0.400, at least 0.420, at least 0.450, at least 0.500, at least 0.550, at least 0.600, at least 0.625, and/or at least 0.650. In some embodiments, the ratio of the polar/hydrogen solubility parameter δ_{(p,h)} to the total solubility parameter tot of the glycerin based and/or ethylene glycol diester plasticizers (i.e., δ_{(p,h)}/tot) may be from 0.365 to 0.650, from 0.375 to 0.650, from 0.400 to 0.650, and/or from 0.425 to 0.650.

Furthermore still, in some embodiments, the molecular weight Mw of the ethylene glycol diester plasticizers may be at least 420 Daltons, at least 440 Daltons, at least 460 Daltons, at least 480 Daltons, at least 500 Daltons, at least 550 Daltons, at least 600 Daltons, at least 650 Daltons, at least 700 Daltons, at least 750 Daltons, and/or at least 800 Daltons. In addition, the molecular weight Mw of the ethylene glycol diester plasticizers may be from 420 to 800 Daltons, from 420 to 750 Daltons, from 440 to 800 Daltons, and/or from 440 to 750 Daltons.

Generally, the plasticizer content of the polymer interlayers of this application will be measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer. In some embodiments, the high rigidity interlayer comprises a layer having a plasticizer content of less than about 35 phr and less than about 30 phr.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, from about 50 to 70 phr, from about 55 to 65 phr, and/or about 60 or 62.5 phr.

When the interlayer includes a multiple layer interlayer, two or more polymer layers within the interlayer may have the substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In addition to the specific plasticizers discussed above, various polymer layers (e.g., the stiff, skin layers) of the interlayers discussed herein may include other types of plasticizers. For example, contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phosphates and adipates, and mixtures and combinations thereof. 3-GEH is particularly preferred. Other examples of suitable plasticizers can include, but are not limited to, di(butoxyethyl) adipate, and bis(2-(2-butoxyethoxy)ethyl) adipate, dioctyl sebacate, nonylphenyl tetraethylene glycol, and mixtures thereof.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers. In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

In addition to plasticizers, it is also contemplated that adhesion control agents (“ACAs”) can also be added to the polymer resins to form polymer interlayers. ACAs generally function to alter and/or improve the adhesion of the interlayer to the glass panels when forming a laminated panel.

Contemplated ACAs include, but are not limited to, magnesium carboxylates/salts. In addition, contemplated ACAs may also include those ACAs disclosed in U.S. Pat. No. 5,728,472, incorporated by reference herein in its entirety, such as residual sodium acetate, potassium acetate, and/or magnesium bis(2-ethyl butyrate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aids, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly(vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. Similarly, PVAc may be formed by hydrolyzing PVAc to the desired acetate and hydroxyl content. In the process of hydrolyzing the poly(vinyl acetate) to form PVB, typically not all of the acetate side groups are converted to hydroxyl groups. Further, the reaction with butyraldehyde typically will not result in all of the hydroxyl groups being converted into acetal groups. Consequently, in any finished PVAc or PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a weight percent basis per ASTM D-1396.

Poly(vinyl acetal) resins having higher or lower residual hydroxyl contents and/or residual acetate contents may also, when combined with at least one plasticizer, ultimately include different amounts of plasticizer. As a result, layers or domains formed of first and second poly(vinyl acetal) resins having different compositions may also have different properties within a single polymer layer or interlayer. Notably, for a given type of plasticizer, the compatibility of the plasticizer in the polymer is largely determined by the hydroxyl content of the polymer. Polymers with a greater residual hydroxyl content are typically correlated with reduced plasticizer compatibility or capacity. Conversely, polymers with a lower residual hydroxyl content typically will result in increased plasticizer compatibility or capacity. As a result, poly(vinyl acetal) resins with higher residual hydroxyl contents tend to be less plasticized and exhibit higher stiffness than similar resins having lower residual hydroxyl contents. Conversely, poly(vinyl acetal) resins having lower residual hydroxyl contents may tend to, when plasticized with a given plasticizer, incorporate higher amounts of plasticizer, which may result in a softer polymer layer that exhibits a lower glass transition temperature than a similar resin having a higher residual hydroxyl content. Depending on the specific resin and plasticizer, these trends could be reversed.

When two poly(vinyl acetal) resins having different levels of residual hydroxyl content are blended with a plasticizer, the plasticizer may partition between the polymer layers or domains, such that more plasticizer can be present in the layer or domain having the lower residual hydroxyl content and less plasticizer may be present in the layer or domain having the higher residual hydroxyl content. Ultimately, a state of equilibrium is achieved between the two resins. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content within multilayered interlayers. Such a correlation also helps to stably maintain the difference in plasticizer content between two or more resins when the plasticizer would otherwise migrate between the resins.

As a result of the migration of plasticizer within an interlayer, the glass transition temperatures of one or more polymer layers may be different when measured alone or as part of a multiple layer interlayer. In some embodiments, the interlayer can include at least one polymer layer having a glass transition temperature, outside of an interlayer, of at least about 33, at least about 34, at least about 35, at least about 36, at least about 37, at least about 38, at least about 39, at least about 40, at least about 41, at least about 42, at least about 43, at least about 44, at least about 45, or at least about 46° C. In some embodiments, the same layer may have a glass transition temperature within the polymer layer of at least about 34, at least about 35, at least about 36, at least about 37, at least about 38, at least about 39, at least about 40, at least about 41, at least about 42, at least about 43, at least about 44, at least about 45, at least about 46, at least about 47° C.

In the same or other embodiments, at least one other polymer layer of the multiple layer interlayer can have a glass transition temperature less than 30° C. and may, for example, have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, not more than about 0, not more than about −1, not more than about −2° C., or not more than about −5° C., measured when the interlayer is not part of an interlayer. The same polymer layer may have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, or not more than about 0° C., when measured outside of the interlayer.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35° C., at least about 35° C., at least about 35° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)//(soft)//(stiff) creates a multilayered interlayer that is easily handled, can be used in conventional lamination methods and that can be constructed with layers that are relatively thin and light. The soft layer comprised of PVAc is generally characterized by a lower residual hydroxyl content (e.g., less than or equal to 16 wt. %, less than or equal to 15 wt. %, or less than or equal to 12 wt. % or any of the ranges disclosed elsewhere), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through extrusion and/or co-extrusion processes. The final multiple layer glass panel laminate of the present disclosure are formed using processes known in the art.

In the extrusion process, thermoplastic resin and plasticizers, including any of those resins and plasticizers described above, are generally pre-mixed and fed into an extruder device. Additives such as colorants and UV inhibitors (in liquid, powder, or pellet form) may be used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material and plasticizers, including any of those resins, plasticizers, and other additives described above, are further mixed and melted, resulting in a melt that is generally uniform in temperature and composition. Embodiments of the present invention may provide for the melt temperature to be approximately 200° C. Once the melt reaches the end of the extruder device, the melt is propelled into the extruder die. The extruder die is the component of the extruder device which gives the final polymer interlayer sheet product its profile. The die will generally have an opening, defined by a lip, that is substantially greater in one dimension than in a perpendicular dimension. Generally, the die is designed such that the melt evenly flows from a cylindrical profile coming out of the die and into the product's end profile shape. A plurality of shapes can be imparted to the end polymer interlayer sheet by the die so long as a continuous profile is present. Generally, in its most basic sense, extrusion is a process used to create objects of a fixed cross-sectional profile. This is accomplished by pushing or drawing a material through a die of the desired cross-section for the end product.

In some embodiments, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. For example, the multiple layer interlayers of the present invention (e.g., in the form of a trilayer interlayer) may be preferably coextruded using a multiple manifold coextrusion device which includes a first die manifold, a second die manifold, and a third die manifold. The coextrusion device may operate by simultaneously extruding polymer melts from each manifold through a die and out of an opening, where the multiple layer interlayer is extruded as a composite of three individual polymer layers. The polymer melts may flow through the die such that the core layer is positioned between the skin layers, so as to result in the manufacture of a trilayer interlayer with the core layer sandwiched between the skin layers. The die opening may include a pair of lips positioned on either side of the opening. Given the positional orientation of the polymer melts, the skin layers may come into contact with the lips. Regardless, the interlayer thickness can be varied by adjusting the distance between die lips located at the die opening.

The thickness of the multiple polymer layers leaving the extrusion die in the co-extrusion process can generally be controlled by adjustment of the relative speeds of the melt through the extrusion die and by the sizes of the individual die lips. According to some embodiments, the total thickness of the multiple layer interlayer can be at least about 13 mils, at least about 20, at least about 25, at least about 27, at least about 30, at least about 31 mils and/or not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, not more than about 9 mils. In some embodiments, each of the layers may have approximately the same thickness, while in other embodiments, one or more layers may have a different thickness than one or more other layers within the interlayer.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, or more of the individual resin layers may include at least one tapered zone. Tapered interlayers may be particularly useful in, for example, heads-up display (HUD) panels in automotive and aircraft applications.

In view of the above, embodiments of the present invention include a polymer interlayer with improved acoustic properties. The polymer interlayer may be a trilayer comprising a soft, core polymer layer, a first stiff, skin polymer layer, and a second stiff, skin polymer layer. The core layer is positioned between the skin layers. The core layer may be formed from a resin comprising polyvinyl acetate (PVAc). For example, the core layer may comprise a hybrid PVAc resin. The first and second skin layers may be formed from PVB, or alternatively, may also be formed from PVAc. For example, the skin layers may be formed from a resin consisting essentially of PVB. Nevertheless, the core layer may have a T_{g} of less than about 20° C. and a tan δ greater than about 2.0.

The tan δ (tan delta) of a material (e.g., a polymer layer) is indicative of certain acoustic properties of the material, and can be obtained from the glass transition of the material. Specifically, the tan δ (or loss factor) of a material indicates the effectiveness of a material's sound damping capabilities (with higher tan δ values indicative of higher damping capabilities). Glass transition of a polymer layer is the transition of the material from the hard, “glassy” state into the viscous, rubbery state, which is reversible; the glass transition temperature is the temperature that marks the transition from the glassy state to the rubbery state. At the glass transition state, a polymer layer provides the highest acoustic damping, and the glass transition temperature is used to characterize the acoustic insulation property of the polymer. The glass transition temperature (T_{g}) can be determined by dynamical mechanical analysis (DMA) in shear mode. The DMA can be used to measure the storage (elastic) modulus (G′) in Pascals and loss (viscous) modulus (G″) in Pascals of the specimen as a function of temperature at a given frequency over a temperature sweep rate. The tan δ for the sample can be calculated based on the ratio of the loss modulus to the storage modulus; stated differently, tan δ=G″/G′. The T_{g} for the sample can be determined based the position of the tan δ peak on the temperature scale in ° C.

Because a polymer layer provides the highest acoustic damping at the glass transition temperature T_{g} of the polymer layer, tan δ peak can also be used to characterize acoustic properties of the polymer layer. As noted above, in general, the higher the tan δ value (including the tan δ peak value) of a polymer layer, the higher the sound damping properties of the polymer layer. Correspondingly, when a polymer layer is part of a multilayer interlayer of the present invention (e.g., a trilayer interlayer including the soft, polymer core layer having a new composition with improved tan δ sandwiched between two stiff, skin polymer layers) and is further used in a laminated glass panel (e.g., having a 2.3-mm glass//interlayer//2.3-mm glass configuration), such glass panel can have beneficial sound insulation properties. Such sound insulation properties may be referred to as sound transmission loss, which is measured in decibels (“dB”) for a given frequency or frequency range.

In various embodiments, the polymer interlayer of the present invention (e.g., the trilayer including the soft, polymer core layer sandwiched between two stiff, skin polymer layers) may comprise a soft, core PVAc layer that exhibits glass transition temperature T_{g} of less than about 20° C., less than 19° C., less than 18° C., less than 17° C., less than 16° C., less than 15° C., less than 10° C., less than 5° C., less than 3° C., less than 0° C., less than −3° C., less than −5° C., and/or less than −10° C. In some embodiments, the glass transition temperature T_{g} of the core layer may be from −10 to 20° C., from −10 to 10° C., from −10 to 0° C., from −5 to 5° C., from −3 to 3° C., or about −2° C., about −1° C., about 0° C., about 1° C., and/or about 2° C. Correspondingly, in some embodiments, the peak tan δ of the soft, core layer of the polymer interlayer of the present invention may be greater than 1.50, greater than 1.50, greater than 1.60, greater than 1.70, greater than 1.80, greater than 1.90, greater than 2.00, greater than 2.10, greater than 2.20, greater than 2.30, greater than 2.40, greater than 2.50, greater than 2.60, greater than 2.70, greater than 2.80, greater than 2.90, greater than 3.00, greater than 3.10, greater than 3.20, greater than 3.30, greater than 3.40, greater than 3.50, greater than 3.60, greater than 3.70, greater than 3.80, greater than 3.90, and/or greater than 4.00. In addition, in some embodiments, the peak tan δ of the soft, core layer of the polymer interlayer of the present invention may be from 1.50 to 4.00, from 1.50 to 2.00, from 1.80 to 3.8, from 2.0 to 3.5, and/or from 2.1 to 3.0.

In various embodiments, the polymer interlayer of the present invention (e.g., the trilayer including the soft, polymer core layer sandwiched between two stiff, skin polymer layers) may itself exhibit a glass transition temperature T_{g} of less than about 20° C., less than 15° C., less than 10° C., less than 5° C., less than 3° C., less than 0° C., less than −3° C., less than −5° C., and/or less than −10° C. In some embodiments, the glass transition temperature T_{g} of the core layer may be from −10 to 20° C., from −10 to 10° C., from 0 to 10° C., from −5 to 5° C., from −3 to 3° C., or about −5° C., or about −° C., or about −3° C., or about −2° C., about −1° C., about 0° C., about 1° C., about 2° C., about 3° C., about 4° C., and/or about 5° C. Correspondingly, in some embodiments, the peak tan δ of the polymer interlayer of the present invention may be greater than 1.20, greater than 1.30, greater than 1.40, greater than 1.50, greater than 1.50, greater than 1.60, greater than 1.70, greater than 1.80, greater than 1.90, and/or greater than 2.00. In addition, in some embodiments, the peak tan δ of the polymer interlayer of the present invention may be from 1.20 to 2.00, from 1.30 to 1.90, from 1.30 to 1.80, from 1.30 to 1.70, 1.30 to 1.60 and/or from 1.40 to 1.60.

When the polymer interlayer of the present invention is laminated between a pair of glass sheets to form a glass panel, as discussed above (i.e., having a 2.3-mm glass//interlayer//2.3-mm glass configuration), the resulting glass panel may have a STL of greater than 30 dB, greater than 31 dB, greater than 32 dB, greater than 33 dB, greater than 34 dB, or greater than 35 dB as measured by weighted average sound transmission loss at 1000 to 10000 Hz. In various embodiments, the interlayers of the present invention have sound insulation, (when in a glass panel having a 2.3-mm glass//interlayer//2.3-mm glass configuration and at 20° C.) of greater than 35 dB, greater than 36 dB, greater than 37 dB decibels, greater than 38 dB, greater than 39 dB, greater than 40 dB, greater than 41 dB, or greater than 42 dB at the coincident frequency of the glass panel (see definition below). In some embodiments, the coincident frequency of a glass panel that includes a polymer interlayer according to embodiments of the present invention may be from 4000 to 5000 Hz or about 4400 Hz. In various embodiments, the interlayers of the present invention have sound insulation, (when in a glass panel having a 2.3-mm glass//interlayer//2.3-mm glass configuration and at 20° C.) of greater than 35 dB, greater than 36 dB, greater than 37 dB, greater than 38 dB, greater than 39 dB, greater than 40 dB, greater than 41 dB, or greater than 42 dB from 1000 Hz to the coincident frequency of the glass panel. In various embodiments, the interlayers of the present invention have sound insulation, (when in a glass panel having a 2.3-mm glass//interlayer//2.3-mm glass configuration and at 20° C.) of greater than 38 dB, greater than 39 dB, greater than 40 dB, greater than 41 dB, greater than 42 dB, greater than 43 dB, greater than 44 dB, greater than 45 dB, greater than 46 dB, greater than 47 dB, greater than 48 dB, greater than 49 dB, or greater than 50 dB from the coincident frequency of the glass panel to 10,000 Hz.

It is understood that glass has a specific critical or coincident frequency at which the speed of an incident acoustical wave in air matches that of a glass bending wave. At the coincident frequency, the acoustic wave is especially effective at causing glass to vibrate, and the vibrating glass is an effective sound radiator at or near the coincident frequency and at frequencies above or below the coincident frequency. As a result, glass exhibits a dip or decrease in sound transmission loss, referred to as the coincidence dip or coincident effect, and the glass becomes transparent to sound.

The coincident frequency of a glass panel can be represented by the following equation (3):

$${f}_{c} = {c}^{2} / 2 π \times {[ {ρ}_{s} / B ]}^{1 / 2} \qquad ( 3 )$$

where c is the sound speed in air, ρₛ is the surface density of the glass panel, and B is the bending stiffness of glass panel. In general, the coincident frequency increases with decreasing thickness of the glass panel. For automotive glazings, the coincident frequency is typically in the range of 3150 to 6000 Hz, which is well within the wind noise frequency region of 2000 to 8000 Hz. For laminated architectural building glass (such as windows), the coincident frequency is generally less than about 3150 Hz.

The above-described polymer interlayer, which has improved acoustic properties may be formed by extruding a first polymer melt to form the soft, core layer and extruding a second polymer melt to form the first and second stiff, skin layers. In some embodiments, the first polymer melt will be fed by a first extruder (e.g., a core extruder), while the second polymer melts will be fed by a second extruder (e.g., a skin extruder) and then split into two streams to form the skin layers. Regardless the core layer and the skin layers will generally be coextruded, such that the core layer is positioned between the first and second skin layers. Notably, the first polymer melt, from which the core layer is formed, comprises a PVAc resin with a plasticizer, as discussed above, that permits the core layer to have a T_{g} of less than about 20° C. and a tan δ greater than about 2.0.

As such, the polymer interlayer of the present invention will include improved sound damping characteristics, as was discussed above and as will be described in more detail in the below examples. Furthermore, embodiments may additionally include a method of forming a laminated glass panel with improved acoustic performance. Such method may include laminating the above-described polymer interlayer between a pair of glass sheets to form a laminated glass panel. Such glass panel may, due to the inclusion of the inventive polymer interlayer, have improved sound insulation characteristics, as discussed above. Beneficially, the compositions of the core and skin layers exhibit suitable compatibility with each other so to provide for adequate adhesion to facilitate bonding of the polymer layers during manufacturing and use of the polymer interlayers. Specifically, in various embodiments described above, the core layer will be formed from hybrid PVAc resin (i.e., a PVAc resin with at least 40 wt. % acetate content, as well as greater than nominal amounts of hydroxyl and aldehyde contents) while the skin layers will consist essentially of PVB. Nevertheless, the non-nominal amounts of PVB in the PVAc resin of the core layer facilitate suitable adhesion between the core and the skin layers.

Although the above embodiments primarily discussed the inventive polymer interlayer being in the form of a trilayer, the polymer interlayer of the present invention may also be in the form of a five-layer interlayer. Such a five-layer interlayer may comprise a soft, core polymer layer, a first stiff, skin polymer layer, a first buffer layer positioned between the core and the first skin layer, a second stiff, skin polymer layer, and a second buffer layer positioned between the core and the second skin layer. The core layer may be formed from a resin comprising PVAc. For example, the core layer may comprise a hybrid PVAc resin. Alternatively, the core layer may be formed from a resin consisting essentially of PVAc. The first and second skin layers may be formed from PVB, or alternatively, may also be formed from PVAc. For example, the skin layers may be formed from a resin consisting essentially of PVB. Furthermore, the buffer layers may comprise a hybrid PVAc resin. Alternatively, the buffer layers may be formed from a resin consisting essentially of PVAc. Nevertheless, the five layer interlayer may provide for improved sound dampening characteristics. For instance, the five-layer interlayer may be formed to have the same or similar tan δ peak values and glass transition temperature T_{g} values as the trilayer polymer interlayer discussed above. Such beneficial characteristics are discussed in more detail in the below examples.

In certain aspects, a polymer interlayer with improved acoustic properties comprises: a first polymer layer; a second polymer layer; and a third polymer layer, wherein said first polymer layer is positioned between said second polymer layer and said third polymer layer, wherein said first polymer layer is formed from a resin comprising polyvinyl acetate (PVAc), wherein said first polymer layer has a T_{g} of less than about 20° C. and a peak tan δ greater than about 2.0.

In other aspects, a method of forming a polymer interlayer with improved acoustic properties comprises the steps of: (a) extruding a first polymer melt to form a first polymer layer; and (b) extruding a second polymer melt to form a second polymer layer and a third polymer layer; wherein upon said extruding of steps (a) and (b), the first polymer layer is positioned between the second and third polymer layers, wherein the first polymer melt comprises a resin including polyvinyl acetate (PVAc), and wherein the first polymer layer has a T_{g} of less than about 20° C. and a peak tan δ greater than about 2.0.

In certain aspects, said extruding of steps (a) and (b) is performed via coextrusion, wherein the peak tan δ of said first polymer layer is between 2.0 and 3.5, and wherein the first polymer layer has a T_{g} of between −5 and 5° C.

In certain aspects, the peak tan δ of said first polymer layer is between 2.0 and 3.5. In certain aspects, said first polymer layer has a T_{g} of between −5 and 5° C.

In certain aspects, a polymer interlayer comprises: a first polymer layer; a second polymer layer; and a third polymer layer, wherein said first polymer layer is positioned between said second polymer layer and said third polymer layer, wherein said first polymer layer is formed from a hybrid resin comprising polyvinyl acetate (PVAc), wherein said first polymer layer has a T_{g} of less than about 20° C. and a peak tan δ greater than about 1.5.

In certain aspects, the peak tan δ of said first polymer layer of any of the polymer interlayers is between 1.5 and 2.0. In certain aspects, said first polymer layer of any of the polymer interlayers has a T_{g} of between −10 and 10° C., or said first polymer layer has a T_{g} of between 0 and 10° C. In certain aspects, the peak tan δ of any of the polymer interlayers is greater than 1.3, or the peak tan δ of said polymer interlayer is between 1.3 and 1.8. In certain aspects, any of said polymer interlayers has a T_{g} of between 0 and 10° C.

In certain aspects, said first and second polymer layers consist essentially of poly (vinyl butyral) (PVB).

In another aspect, a polymer interlayer comprises: a first polymer layer; a second polymer layer; and a third polymer layer, wherein said first polymer layer is positioned between said second polymer layer and said third polymer layer, wherein said first polymer layer is formed from a resin comprising polyvinyl acetate (PVAc), wherein said polymer interlayer layer has a T_{g} of less than about 20° C. and a peak tan δ greater than about 1.3.

In certain aspects, the peak tan δ of said polymer interlayer is greater than 1.5. In certain aspects, said polymer interlayer has a T_{g} of less than 0° C.

In certain aspects, said first polymer layer consists essentially of polyvinyl acetate (PVAc). In certain aspects, said second and third polymer layers are bonding layers that comprise a hybrid polyvinyl acetate (PVAc).

In certain aspects, the polymer interlayer further comprises a fourth polymer layer and a fifth polymer layer, wherein said second polymer layer is positioned between said first polymer layer and said fourth polymer layer, and wherein said third polymer layer is positioned between said first polymer layer and said fifth polymer layer. In certain aspects, said fourth and fifth polymer layers are skin layers that consist essentially of poly (vinyl butyral) (PVB).

In certain aspects, the resin of said first polymer layer of any of the polymer interlayers comprises a glycerin based and/or an ethylene glycol diester plasticizer. In certain aspects, the resin comprises between 50 and 70 phr of the plasticizer. In certain aspects, the plasticizer of said first polymer layer of any of the polymer interlayers comprises tributyrin, or the plasticizer of said first polymer layer comprises a diester with four or more repeating units of ethylene glycol, or the plasticizer of said first polymer layer comprises polyethylene glycol bis-(2-ethylhexanoate), or the plasticizer of said first polymer layer comprises molecules with an oxygen to carbon ratio of at least 0.32, or the plasticizer of said first polymer layer comprises ethylene glycol diester, and wherein the plasticizer has a molecular weight of at least 420 Daltons, or the plasticizer of said first polymer layer has a total solubility parameter δₜₒₜ comprised of contributions from a dispersion solubility parameter δ_{d}, a polar solubility parameter δₚ, and a hydrogen bonding solubility parameter δₕ, wherein a ratio of contributions from the polar solubility parameter δₚ and the hydrogen bonding solubility parameter δₕ with respect to the total solubility parameter δₜₒₜ is at least 0.365.

In certain aspects, the T_{g} of said first polymer layer of any of the polymer interlayers is less than a T_{g} of both said second polymer layer and said third polymer layers.

In certain aspects, the resin of any of the polymer interlayers comprises from 40 to 80 wt. % acetate content, from 5 to 20 wt. % hydroxyl content, and from 20 to 40 wt. % aldehyde content, or the resin comprises at least 50 wt. % acetate content, or the resin comprises from 10 to 15 wt. % hydroxyl content, or the resin comprises from 10 to 45 wt. % aldehyde content.

In certain aspects, a thickness of any of said polymer interlayers is generally constant along a length of said polymer interlayer. In certain aspects, a thickness of any of said polymer interlayers varies along a length of said polymer interlayer, such that said polymer interlayer has a wedge shape.

### Example 1

Two polymer sheets were formed and tested, using dynamic mechanical analysis (DMA), to determine tan δ values for the sheets over a range of temperatures. A first sheet “EX1-S1” was formed using a 200 K to 700 K Dalton PVAc monopolymer resin, with 48 phr of tributyrin plasticizer. A second sheet “EX1-S2” was formed using 50,000 to 600,000 Dalton PVB resin (comprising 10.5 wt. % PVOH, 2.0 wt. % PVAc, and 87.5 wt. % PVB), with 75 phr of triethylene glycol di-(2-ethylhexanoate) plasticizer. Each sheet, EX1-S1 and EX1-S2, was produced from resin via a compression molding technique that included forming the sheet using a steam heated press. The tan δ measurements were carried out on samples of the sheets that were dried in a desiccator overnight. The testing used torsional and tensile mode dynamic mechanical analysis (DMA). The samples were tested using a Rheometrics Solids Analyzer over a temperature range −40 to 20° C. at an oscillation frequency of 1 Hz. The frequency dependence parameters were derived using “time-temperature superposition,” in which the DMA was performed from 0.3 rad/s to 300 rad/s at −40° C., −20° C., −10° C., 0° C., 10° C., and 20° C. for each sample.

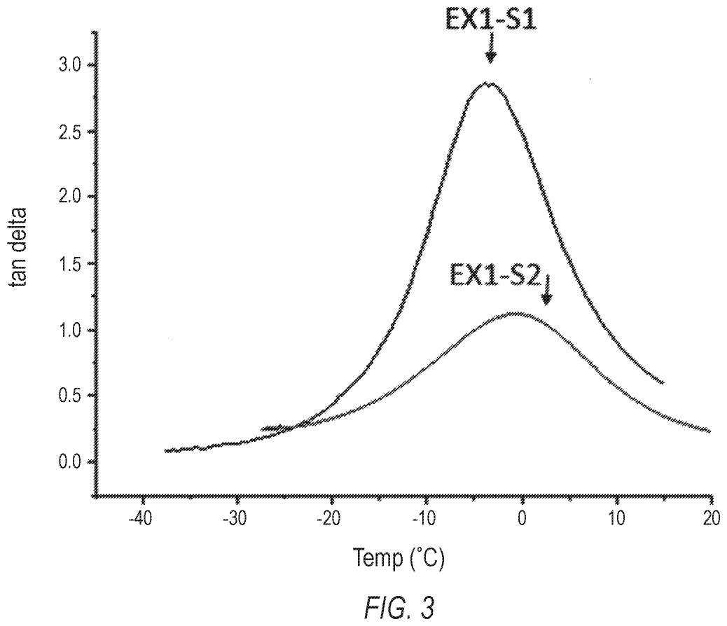

The resulting tan δ plots for each of the two polymer layers, sheets EX1-S1 and EX1-S2 are illustrated in FIG. 3. As illustrated, sheet EX1-S1, which comprises PVAc resin with tributyrin plasticizer, yielded a peak tan δ of 2.9 at a T_{g} of −3° C. Such a loss factor (as indicated by the tan δ value and T_{g}) is an improvement over the polymer layer of sheet EX1-S2 that includes standard PVB and triethylene glycol di-(2-ethylhexanoate) plasticizer. Specifically, as illustrated, sheet EX1-S2 yielded a peak tan δ of only 1.3 at a T_{g} of −1° C. As such, the polymer layer comprising PVAc with tributyrin plasticizer (i.e., sheet EX1-S1) shows an increase in the peak tan δ and/or the loss factor of over 100% with respect to a similar PVB formulation (i.e., sheet EX1-S2) at the same or proximate T_{g}.

### Example 2

Three polymer sheets were formed and tested, using dynamic mechanical analysis (DMA), to determine tan δ values for the sheets over a range of temperatures. A first sheet “EX2-S1” was formed from a 500 K Dalton PVAc monopolymer resin, with 60 phr of poly(ethylene glycol) bis(2-ethylhexanoate) plasticizer. A second sheet “EX2-S2” was also formed from a 500 K Dalton PVAc monopolymer resin, with 60 phr of poly(ethylene glycol) bis(2-ethylhexanoate) plasticizer. Finally, a third sheet “EX2-S3” was formed from a 50,000 to 600,000 Dalton PVB resin (comprising 10.5 wt. % PVOH, 2.0 wt. % PVAc, and 87.5 wt. % PVB), with 75 phr of triethylene glycol di-(2-ethylhexanoate) plasticizer. Each sheet, EX2-S1, EX2-S2, and EX2-S3, was produced from a resin via a compression molding technique that included forming the sheet using a steam heated press. The tan δ measurements were carried out on samples of the sheets that were dried in a desiccator overnight. The testing used torsional and tensile mode dynamic mechanical analysis (DMA). The samples were tested using a Rheometrics Solids Analyzer over a temperature range −20 to 60° C. at an oscillation frequency of 1 Hz. The frequency dependence parameters were derived using “time-temperature superposition,” in which the DMA was performed from 0.3 rad/s to 300 rad/s at −20° C., −10° C., 0° C., 10° C., 20° C., 30° C., 40° C., and 60° C. for each sample.

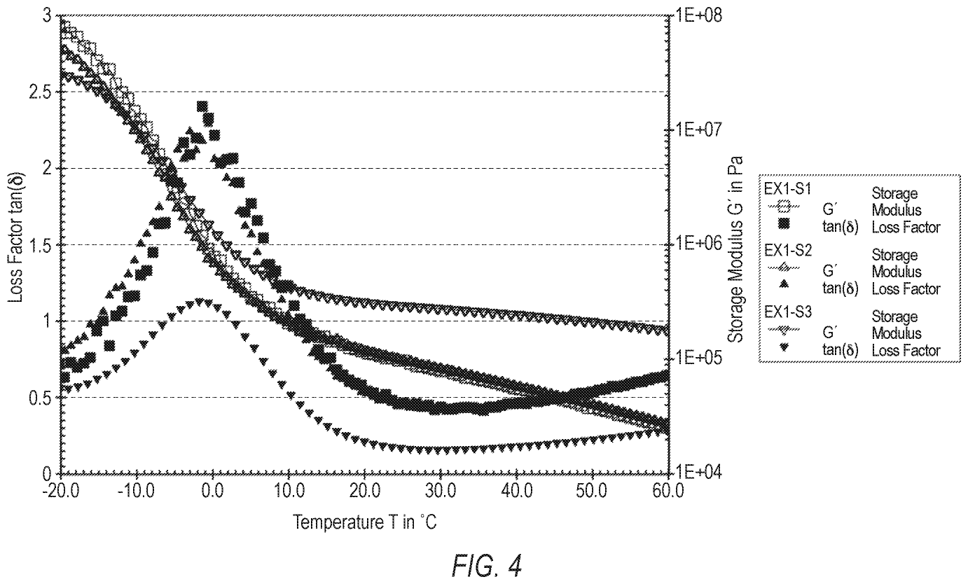

The resulting tan δ plots for each of the three polymer layers, sheets EX2-S1, EX2-S2, and EX2-S3, are illustrated in FIG. 4. As illustrated, sheets EX2-S1 and EX2-S2, which both comprise PVAc resin with poly(ethylene glycol) bis(2-ethylhexanoate) plasticizer, yielded a peak tan δ of about 2.2 at a T_{g} of about −1° C. Such a loss factor (as indicated by the tan δ value and T_{g}) is an improvement over the polymer layer of sheet EX2-S3 that includes standard PVB and triethylene glycol di-(2-ethylhexanoate) plasticizer. Specifically, as illustrated, sheet EX2-S3 yielded a peak tan δ of only about 1.1 at a T_{g} of −1° C. As such, the polymer layers comprising PVAc with poly(ethylene glycol) bis(2-ethylhexanoate) plasticizers (i.e., sheets EX2-S1 and EX2-S2) show an increase in the peak tan δ and/or the loss factor of over 100% with respect to a similar PVB formulation (i.e., sheet EX2-S3) at the same or proximate T_{g}.

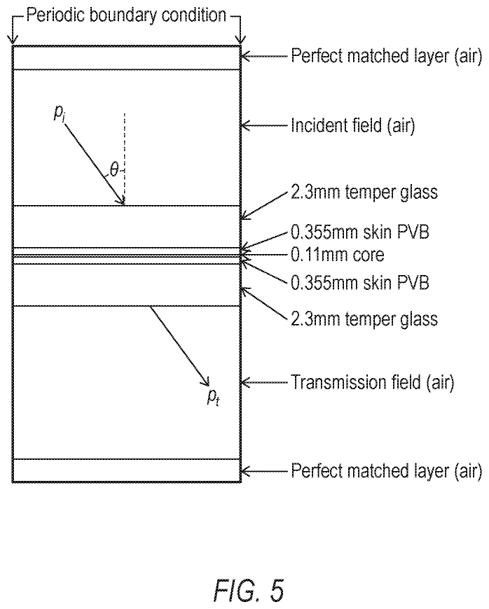

After obtaining the tan δ plots, simulations were run for two of the polymer layers, i.e., EX2-S1 and EX2-S3, to obtain sound loss transmission (STL) data for cases in which the polymer layers were included in a laminated glass panel. Specifically, the polymer layers modeled as forming the core layer in a trilayer multilayer (i.e., skin layer//core layer//skin layer) that was sandwiched between a pair of glass plates. A STL model was established and simulations were conducted by a finite element software tool COMSOL. The STL model was a two-dimension model, as illustrated in FIG. 5. In this model, the glass panel comprised a “2.3 mm glass plate—0.355 mm skin layer (PVB)—0.11 mm core layer—0.355 mm skin layer (PVB)—2.3 mm glass plate” laminate, which was embedded in an infinite air space (infinite space is constructed by applying a perfect matched layer). The frequency dependent parameters of both EX2-S1 (PVAc) and EX2-S3 (PVB), as measured by DMA, were applied to the model. The STL of the diffused sound STL_{d} field were calculated by the following equation (4):

$${STL}_{d} = - 10 {log}_{10} ( \frac{{\int }_{0}^{1.361} τ ( θ ) sin ( θ ) cos ( θ ) d θ}{{\int }_{0}^{1.361} sin ( θ ) cos ( θ ) d θ} ) \qquad ( 4 )$$

where

$$τ ( θ ) = \frac{{p}_{t}^{2}}{{p}_{i}^{2}}$$

was the sound intensity transmission coefficient, θ is the angle of incident plane wave, pₜ is the transmitted sound pressure, and pᵢ is the incident sound pressure. It was assumed that the incident angle was uniformly distributed from 0° to 78° (1˜1.361 in radian). The integral was calculated by Simpson's law using MATLAB software.

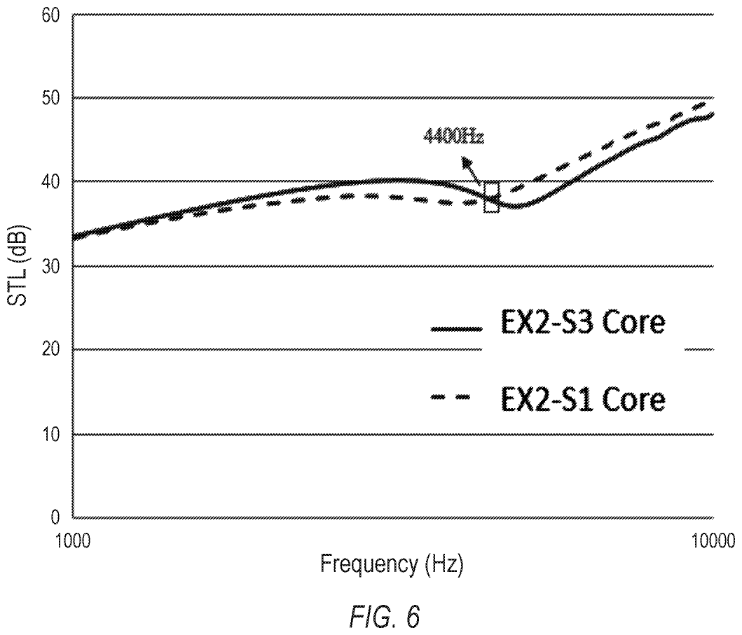

The resulting, simulated STL data is illustrated graphically in FIG. 6. From the STL data, it can be seen that the coincidence frequency of the laminated glass panel with the PVAc core layer (i.e., EX2-S1) is shifted to a lower frequency with respect to the laminated glass panel with the PVB core layer (i.e., EX2-S3). This is likely due to PVAc being generally stiffer than our current PVB above 100 Hz. Regardless, STL performance of the laminated glass panel with PVAc core layer was lower at low frequencies (i.e., frequencies below 4400 Hz). However, at frequencies higher than the coincidence frequency of the laminated glass panel with the PVB core layer (i.e., EX2-S3), the STL of the laminated glass panel with the PVAc core layer (i.e., EX2-S1) has a 2+dB improvement over that of the laminated glass panel with the PVB core layer. This result is likely due to both the damping and stiffness of the PVAc being greater than that of PVB.

### Example 3

Four polymer sheets were formed and tested, using dynamic mechanical analysis (DMA), to determine tan δ values for the sheets over a range of temperatures. A first sheet “EX3-S1” was formed from a 500 K Dalton PVAc monopolymer resin, with 60 phr of poly(ethylene glycol) bis(2-ethylhexanoate) plasticizer. A second sheet “EX3-S2” was formed from a 500 K Dalton PVAc monopolymer resin, with 60 phr of poly(ethylene glycol) bis(2-ethylhexanoate) plasticizer. A third sheet “EX3-S3” was formed from a 500 K Dalton PVAc monopolymer resin, with 62.5 phr of poly(ethylene glycol) bis(2-ethylhexanoate) plasticizer. Finally, a fourth sheet “EX3-S4” was formed from a 50,000 to 600,000 Dalton PVB resin (comprising 10.5 wt. % PVOH, 2.0 wt. % PVAc, and 87.5 wt. % PVB), with 75 phr of triethylene glycol di-(2-ethylhexanoate) plasticizer. Each sheet, EX3-S1, EX3-S2, EX3-S3, EX3-S4 was produced from a resin via a compression molding technique that included forming the sheet using a steam heated press. The tan δ measurements were carried out on samples of the sheets that were dried in a desiccator overnight. The testing used torsional and tensile mode dynamic mechanical analysis (DMA). The samples were tested using a Rheometrics Solids Analyzer over a temperature range −20 to 60° C. at an oscillation frequency of 1 Hz. The frequency dependence parameters were derived using “time-temperature superposition,” in which the DMA was performed from 0.3rad/s to 300rad/s at −20° C., −10° C., 0° C., 10° C., 20° C., 30° C., 40° C., and 60° C. for each sample.

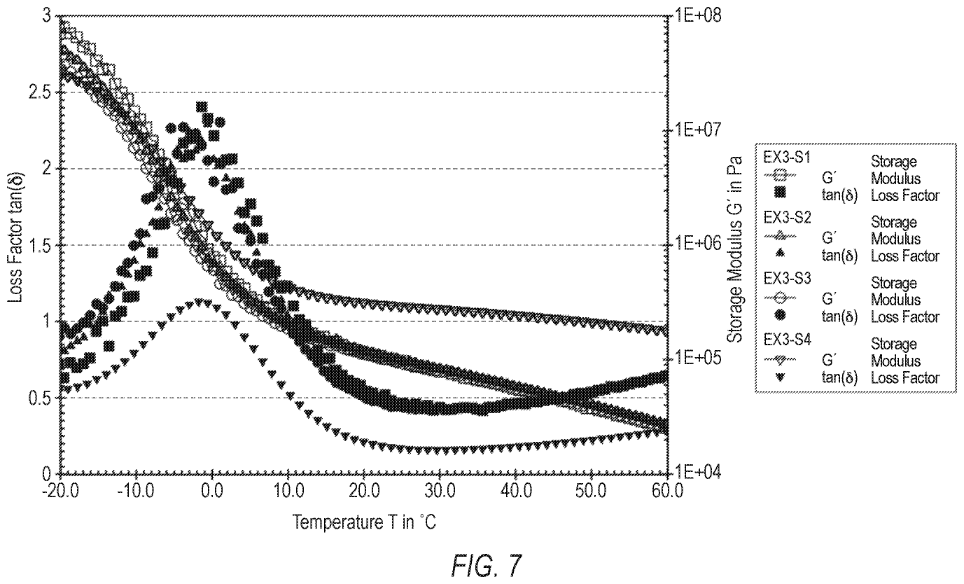

The resulting tan δ plots for each of the four polymer layers, sheets EX3-S1, EX3-S2, EX3-S3, and EX3-S4 are illustrated in FIG. 7. As illustrated, sheets EX3-S1 and EX3-S2, which both comprise PVAc resin with 60 phr poly(ethylene glycol) bis(2-ethylhexanoate) plasticizer, yielded a peak tan δ of about 2.2 at a T_{g} of about −1° C. Sheet EX3-S3, which comprises PVAc resin with 62.5 phr poly(ethylene glycol) bis(2-ethylhexanoate) plasticizer, yielded a slightly larger peak tan δ of about 2.3, with a slightly lower T_{g} of about −2° C. Each of the measured loss factors (as indicated by the tan δ values and T_{g}'s) was an improvement over the polymer layer of sheet EX3-S4 that includes standard PVB and triethylene glycol di-(2-ethylhexanoate) plasticizer. Specifically, as illustrated, sheet EX3-S4 yielded a peak tan δ of only about 1.1 at a T_{g} of −1° C. As such, the polymer layers comprising PVAc with poly(ethylene glycol) bis(2-ethylhexanoate) plasticizers (i.e., sheets EX3-S1, EX3-S2, and EX3-S3) show an increase in the peak tan δ and/or the loss factor of over 100% with respect to a similar PVB formulation (i.e., sheet EX3-S4) at the same or proximate T_{g}.

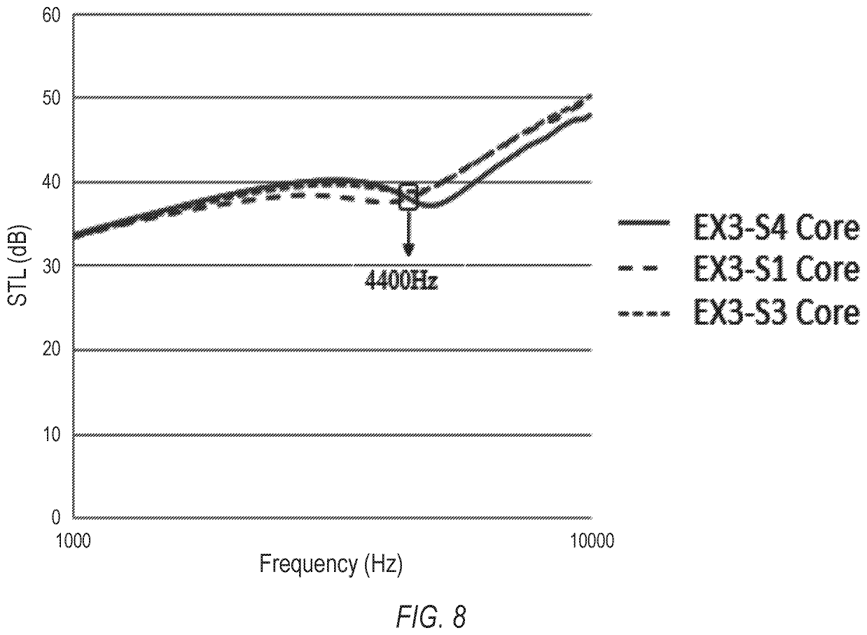

After obtaining the tan δ plots, simulations were run for three of the polymer sheets, i.e., EX3-S1, EX3-S3, and EX3-S4 to obtain sound loss transmission (STL) data for cases in which the polymer sheets were included in a laminated glass panel. Specifically, the polymer sheets were simulated as part of a laminated glass panel using the STL model described above in Example 2. The resulting simulated STL data is illustrated in FIG. 8.

From the STL data, it can be seen that the STL loss below 4400 Hz by the laminated glass panel having the PVAc with 60 phr plasticizer core layer (i.e., EX3-S1) with respect to the laminated glass panel having the PVB core layer (i.e., EX3-S4) was not present with the laminated glass panel having the PVAc with 62.5 phr plasticizer (i.e., EX3-S3). This result is likely due to the 62.5 phr PVAc being softer than 60 phr PVAc so that the coincidence frequency of the laminated glass panel having the PVAc with 62.5 phr plasticizer (i.e., EX3-S3) was shifted to a higher frequency. Such a shifting provided that the STL performance at low frequency (below the coincidence frequency) of the laminated glass panel having the PVAc with 62.5 phr plasticizer (i.e., EX3-S3) was similar to the performance level of the laminated glass panel having the PVB core layer (i.e., EX3-S4).

At and above 4400 Hz, the laminated glass panel having the PVAc with 62.5 phr plasticizer (i.e., EX3-S3) provided 2 dB improvement when compared with the laminated glass panel having the PVB core layer (i.e., EX3-S4). Such a result is likely due to the damping characteristics of PVAc being much higher than that of PVB. For frequencies greater than 4400 Hz, the STL curve of 60 phr plasticizer core layer (i.e., EX3-S1) overlaps that the laminated glass panel having the PVAc with 62.5 phr plasticizer (i.e., EX3-S3). This result is likely due to the damping of PVAc with 62.5 phr plasticizer being higher than that of PVAc with 60 phr plasticizer, and the higher damping of the laminated glass panel having the PVAc with 62.5 phr plasticizer (i.e., EX3-S3) in that frequency region compensates the STL loss given by a decrease of modulus.

### Example 4

As provided below in Table 1, eight exemplary hybrid PVAc resin samples, Hybrid Resin Samples (“HRS”) 1-8, were formed, each with various amounts of acetate content, hydroxyl content, and aldehyde content. For each sample, the percent of hydrolysis used in forming the sample is also provided.

TABLE 1

| Sample | % hydrolysis | Wt. % PVAc | Wt. % PVB | Wt. % PVOH |
|---|---|---|---|---|
| HRS-1 | 17.4 | 88.7 | 4.4 | 6.9 |
| HRS-2 | 21.5 | 84.7 | 9 | 6.3 |
| HRS-3 | 31.4 | 76 | 16.5 | 7.5 |
| HRS-4 | 62.1 | 44.6 | 47.5 | 7.9 |
| HRS-5 | 61.0 | 45.4 | 47.5 | 7 |
| HRS-6 | 33.4 | 72.8 | 22.5 | 4.7 |
| HRS-7 | 37.2 | 70 | 23.2 | 6.8 |
| HRS-8 | 47.0 | 59.9 | 33.9 | 6.2 |

### Sub-Example 4A

Three polymer sheets were formed and tested, using dynamic mechanical analysis (DMA), to determine tan δ values for the sheets over a range of temperatures. A first sheet “EX4A-S1” was formed from the HRS-2 sample resin, with 63.4 phr of poly(ethylene glycol) bis(2-ethylhexanoate) plasticizer. A second sheet “EX4A-S2” was formed from the HRS-4 sample resin, with 59.5 phr of triethylene glycol di-(2-ethylhexonate) plasticizer. Finally, a third sheet “EX4A-S3” was formed from a 50,000 to 600,000 Dalton PVB resin (comprising 10.5 wt. % PVOH, 2.0 wt. % PVAc, and 87.5 wt. % PVB), with 75 phr of triethylene glycol di-(2-ethylhexanoate) plasticizer. Each sheet, EX4A-S1, EX4A-S2, and EX4A-S3 was produced from a resin via a compression molding technique that included forming the sheet using a steam heated press. The tan δ measurements were carried out on samples of the sheets that were dried in a desiccator overnight. The testing used torsional and tensile mode dynamic mechanical analysis (DMA). The samples were tested using a Rheometrics Solids Analyzer over a temperature range −20 to 60° C. at an oscillation frequency of 1 Hz. The frequency dependence parameters were derived using “time-temperature superposition,” in which the DMA was performed from 0.3rad/s to 300rad/s at −20° C., −10° C., 0° C., 10° C., 20° C., 30° C., 40° C., and 60° C. for each sample.

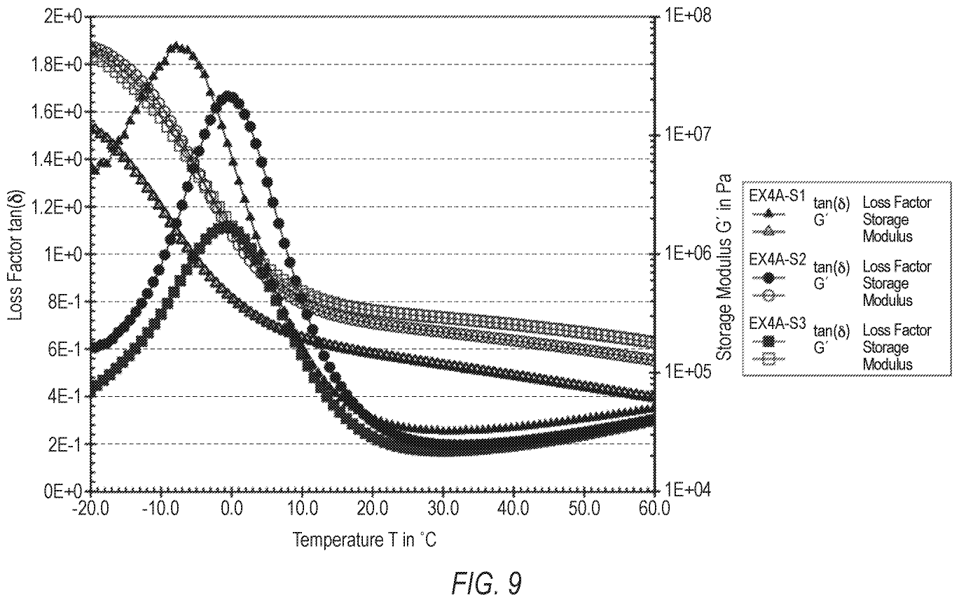

The resulting tan δ plots for each of the three polymer layers, sheets EX4A-S1, EX4A-S2, and EX4A-S3 are illustrated in FIG. 9. As shown, sheet EX4A-S1 (formed from a hybrid PVAc resin) yielded a peak tan δ of about 1.88 at a T_{g} of about −6° C. Sheet EX4A-S2 (also formed from a hybrid PVAc resin) yielded a slightly smaller peak tan δ of about 1.66, with a slightly higher T_{g} of about −0.4° C. Each of the measured loss factors (as indicated by the tan δ values and T_{g}'s) was an improvement over the polymer layer of sheet EX4A-S3 that included standard PVB resin and triethylene glycol di-(2-ethylhexanoate) plasticizer. Specifically, as illustrated, sheet EX4A-S3 yielded a peak tan δ of only about 1.1 at a T_{g} of −1° C. As such, polymer layers comprising hybrid PVAc with either poly(ethylene glycol) bis(2-ethylhexanoate) or triethylene glycol di-(2-ethylhexonate) plasticizers (i.e., sheets EX4A-S1 and EX4A-S2) show an increase in the peak tan δ and/or the loss factor with respect to a similar PVB formulations (i.e., sheet EX4A-S3) at the same or proximate T_{g}.

Although not illustrated in FIG. 9, two additional polymer sheets were created with the HRS-2 and HRS-4 resin samples and tested in the same manner described above. In particular, a fourth sheet “EX4A-S4” was formed from the HRS-2 sample resin, with 68.7 phr of poly(ethylene glycol) bis(2-ethylhexanoate) plasticizer. And a fifth sheet “EX4A-S5” was formed from the HRS-4 sample resin, with 55.6 phr of triethylene glycol di-(2-ethylhexonate) plasticizer. Each sheet was tested using the DMA processes described above. The EX4A-S4 sheet yielded a peak tan δ of about 1.8 at a T_{g} of about −7° C. The EX4A-S5 sheet yielded a peak tan δ of about 1.64 at a T_{g} of about 1° C. As such, the EX4A-S4 and EX4A-S5 sheets confirmed that the hybrid PVAc polymer layers showed improved peak tan δ values and/or loss factor values in comparison to a standard PVB formulations.

### Sub-Example 4B

Three trilayer polymer interlayers were formed and tested, using a DMA process described in more detail below, to determine tan δ values for the interlayers. Two of the polymer interlayers include core layers formed from the hybrid PVAc samples described above in this Example 4B. In particular, a first polymer interlayer “EX4B-S1” was laminated using a core layer comprised of the HRS-4 sample resin, with 59.5 phr of triethylene glycol di-(2-ethylhexonate) plasticizer. The core layer was formed to a thickness of about 0.18 mm. Each of the skin layers of EX4B-S1 comprised a PVB resin (comprising 21.1 wt. % PVOH, 2.0 wt. % PVAc, and 87.5 wt. % PVB), with 36.5 phr of triethylene glycol di-(2-ethylhexanoate) plasticizer. The thickness of each of the skin layers was about 0.32 mm. Similarly, a second polymer interlayer “EX4B-S2” was laminated using a core layer comprised of the HRS-4 sample resin, with 55.6 phr of triethylene glycol di-(2-ethylhexonate) plasticizer. The core layer was formed to a thickness of about 0.18 mm. Each of the skin layers of EX4B-S2 comprised a PVB resin (comprising 18.7 wt. % PVOH, 2.0 wt. % PVAc, and 87.5 wt. % PVB), with 36.5 phr of triethylene glycol di-(2-ethylhexanoate) plasticizer. The thickness of each of the skin layers was about 0.32 mm. Furthermore, a third polymer interlayer “EX4B-S3” was laminated using a core layer comprised of a PVB resin (comprising 10.5 wt. % PVOH, 2.0 wt. % PVAc, and 87.5 wt. % PVB). The core layer was formed to a thickness of about 0.11 mm. Each of the skin layers of EX4B-S3 comprised a PVB resin (comprising 18.7 wt. % PVOH, 2.0 wt. % PVAc, and 87.5 wt. % PVB), with 38 phr of triethylene glycol di-(2-ethylhexanoate) plasticizer. The thickness of each of the skin layers was about 0.35 mm.

Each of the polymer interlayers EX4B-S1-EX4B-S3 was tested, using DMA, to determine tan δ values for the interlayers over a range of temperatures. The tan δ measurements were carried out on samples of the interlayers that were dried in a desiccator overnight. The testing used torsional and tensile mode DMA. The samples were tested using a Rheometrics Solids Analyzer over a temperature range −20 to 60° C. at an oscillation frequency of 1 Hz. The frequency dependence parameters were derived using “time-temperature superposition,” in which the DMA was performed from 0.3 rad/s to 300 rad/s at −20° C., −10° C., 0° C., 10° C., 20° C., 30° C., 40° C., and 60° C. for each sample.

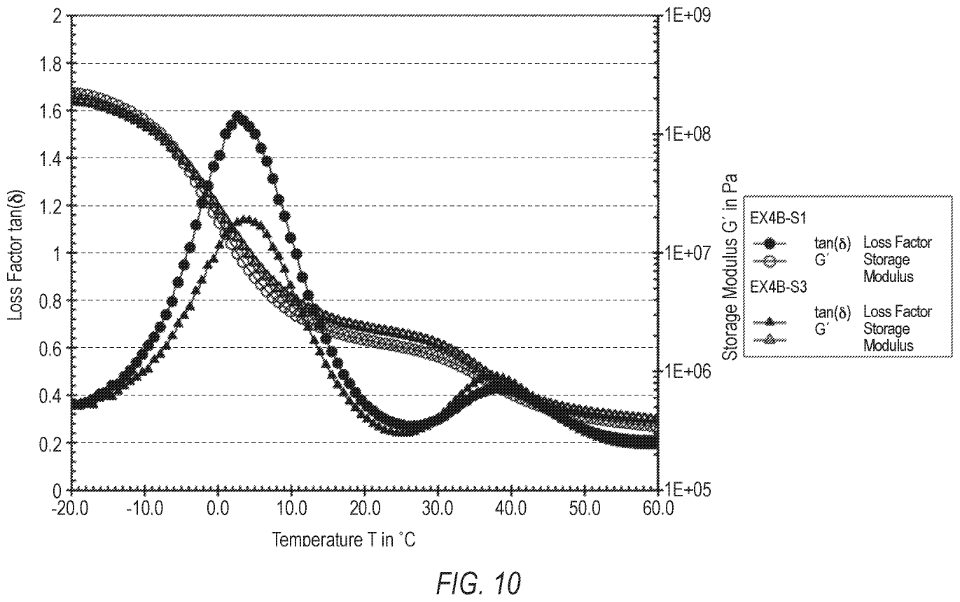

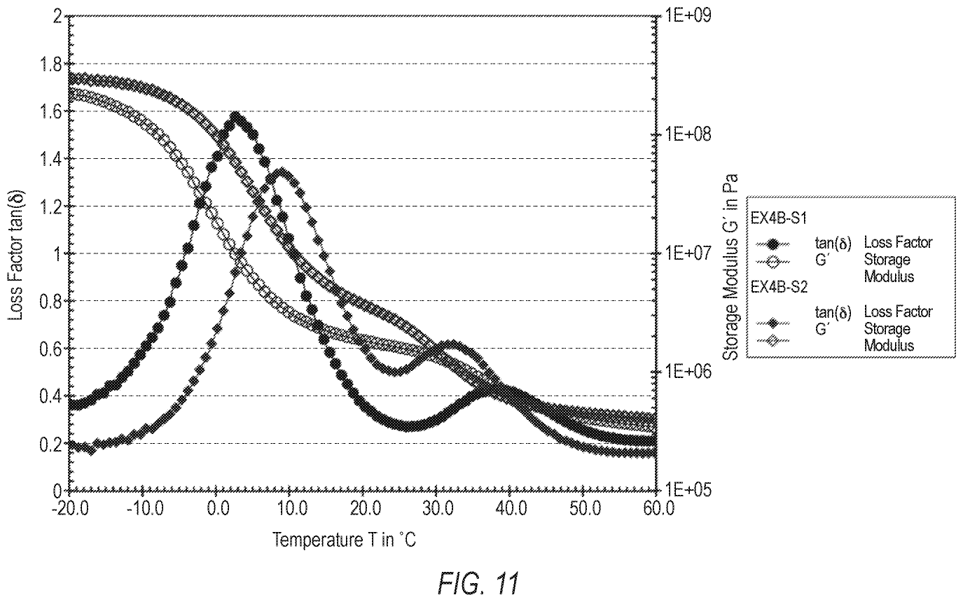

The resulting tan δ plots for each of the three trilayer polymer interlayers EX4B-S1-EX4B-S3 are illustrated in FIGS. 10 and 11. In particular, tan δ plots for EX4B-S1 and EX4B-S3 are shown in FIG. 10, while tan δ plots for EX4B-S1 and EX4B-S2 are shown in FIG. 11. As illustrated in FIG. 10, interlayer EX4B-S1 (formed with a core layer comprising the hybrid PVAc resin) yielded a peak tan δ of about 1.59 at a T_{g} of about 3° C., whereas interlayer EX4B-S3 (formed with a core layer comprising standard PVB resin) yielded a peak tan δ of about 1.17 at a T_{g} of about 4° C. As such, the measured loss factor (as indicated by the tan δ values and T_{g}'s) of the interlayer formed with a core layer comprising a hybrid PVAc was an improvement over the loss factor of the interlayer formed with the core layer comprising standard PVB. Specifically, the trilayer interlayer with a core layer comprising hybrid PVAc (i.e., interlayer EX4B-S1) showed an increase in the peak tan δ and/or the loss factor with respect to a trilayer interlayer with a standard PVB core layer (i.e., interlayer EX4B-S3) at the same or proximate T_{g}

Turning to FIG. 11, the graph reproduces tan δ plot for the EX4B-S1 interlayer (formed with a core layer comprising the hybrid PVAc resin HRS-4 with 59.5 phr of triethylene glycol di-(2-ethylhexonate) plasticizer), as discussed above, as well as showing the tan δ plot for the EX4B-S2 interlayer (formed with a core layer comprising the hybrid PVAc resin HRS-4 with 55.6 phr of triethylene glycol di-(2-ethylhexonate) plasticizer). As such, the EX4B-S1 interlayer had slightly more plasticizer in its core layer than the EX4B-S2 interlayer. As shown, interlayer EX4B-S1 yielded a peak tan δ of about 1.59 at a T_{g} of about 3° C., whereas interlayer EX4B-S2 yielded a peak tan δ of about 1.37 at a T_{g} of about 9° C. As such, the measured loss factor (as indicated by the tan δ values and T_{g}'s) of the interlayer formed with a core layer comprising a hybrid PVAc having a greater amount of plasticizer was an improvement over the loss factor of the interlayer formed with the core layer comprising a hybrid PVAc having a lesser amount of plasticizer. Specifically, the trilayer interlayer with a core layer comprising hybrid PVAc with 59.5 phr of plasticizer (i.e., interlayer EX4B-S1) showed an increase in the peak tan δ and/or the loss factor with respect to a trilayer interlayer with a core layer comprising hybrid PVAc with 55.6 phr of plasticizer (i.e., interlayer EX4B-S2) at the same or proximate T_{g}

### Sub-Example 4C

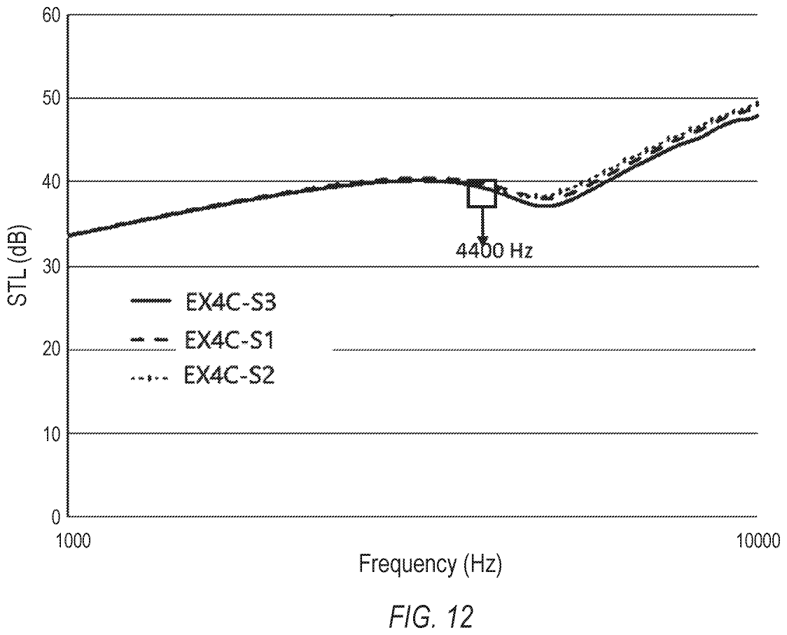

After obtaining the tan δ plot for the EX4A-S2 and EX4A-S3 sheets described in Sub-Example 4A, simulations were run for the sheets to obtain sound loss transmission (STL) data for cases in which the polymer from the polymer sheets were included in laminated glass panels. Specifically, the polymer from the polymer sheets were simulated as part of laminated glass panels using, in general, the STL model described above in Example 2. The frequency dependent parameters of both EX4A-S2 and EX4A-S3 sheets, as measured by DMA in Sub-Example 4A, were applied to the respective models. The resulting simulated STL data is illustrated in FIGS. 12-15.

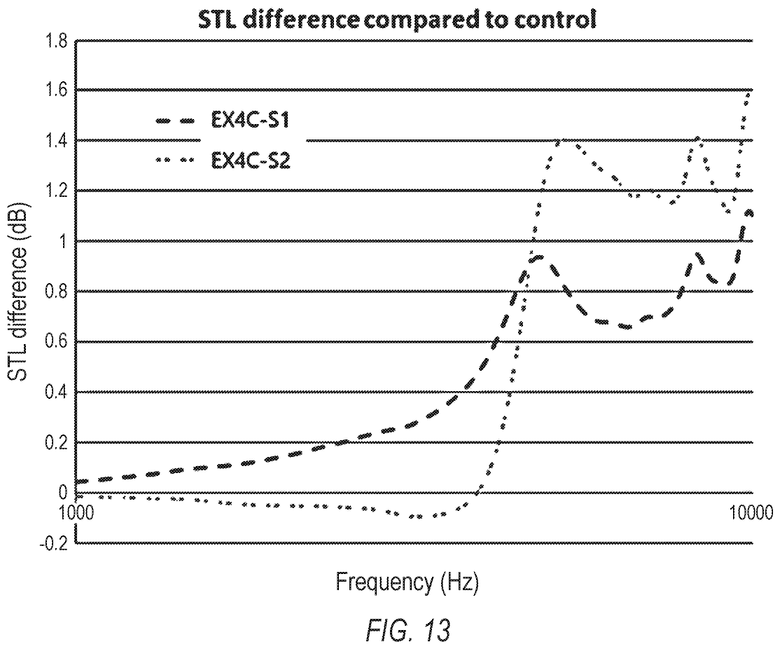

In more detail, a first simulation, “EX4C-S1”, was run with the polymer from the EX4A-S2 sheet forming the core layer of a trilayer polymer interlayer included in a simulated laminated glass panel. The core layer was modeled to have a thickness of 0.22 mm. The skin layers of the trilayer polymer interlayer were modeled to include a standard PVB resin (comprising 21.1 wt. % PVOH, 2.0 wt. % PVAc, and 87.5 wt. % PVB) with 36.5 phr of triethylene glycol di-(2-ethylhexanoate) plasticizer. The skin layers were each modeled to have a thickness of 0.3 mm. A second simulation, “EX4C-S2”, was run with parameters the same as described above for EX4C-S1, except the core layer was modeled to be 0.18 mm, and each of the skin layers was modeled to have a thickness of 0.32 mm. A third simulation, “EX4C-S3”, was run with the polymer from the EX4A-S3 sheet forming the core layer of a trilayer polymer interlayer included in a simulated laminated glass panel. The core layer was modeled to have a thickness of 0.11 mm. The skin layers of the trilayer polymer interlayer were modeled to include a standard PVB resin (comprising 18.7 wt. % PVOH, 2.0 wt. % PVAc, and 87.5 wt. % PVB), with 38 phr of triethylene glycol di-(2-ethylhexanoate) plasticizer. The skin layers were each modeled to have a thickness of 0.355 mm. Except as provided above in this paragraph, the simulation models for EX4C-S1, EX4C-S2, and EX4C-S3 were consistent with the STL model described above in Example 2. Simulated plots of STL data for EX4C-S1, EX4C-S2, and EX4C-S3 are shown in FIGS. 12 and 13.

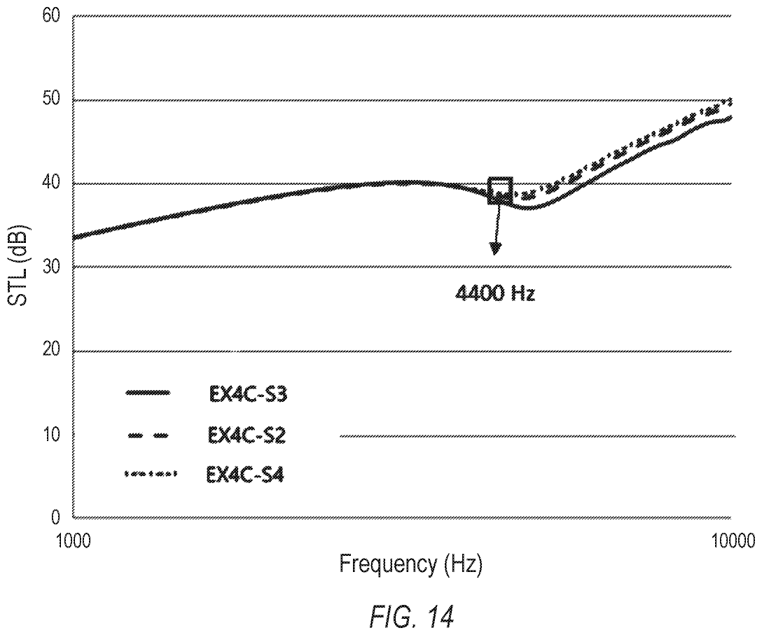

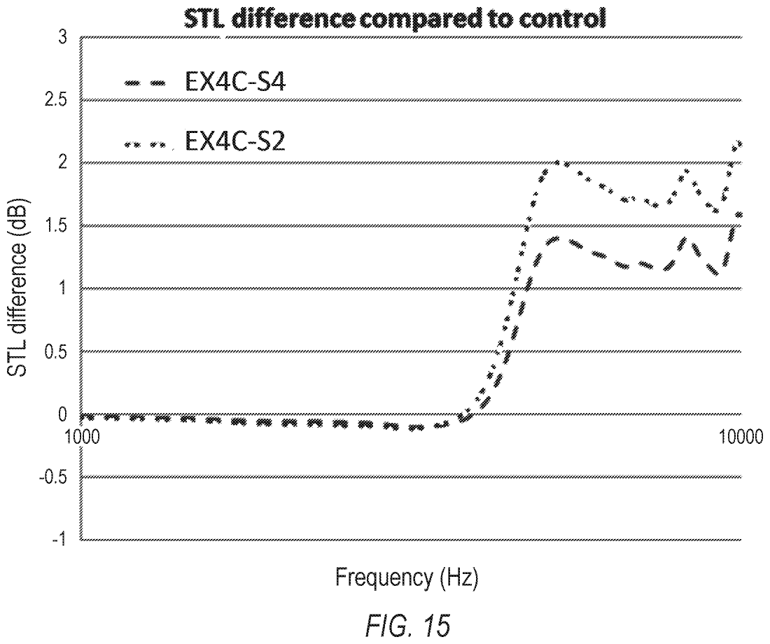

Finally, a fourth simulation, “EX4C-S4”, was run with parameters the same as described above for EX4C-S2, except the skin layers of the trilayer polymer interlayer were modeled to include a standard PVB resin (comprising 22.3 wt. % PVOH, 2.0 wt. % PVAc, and 87.5 wt. % PVB) with 34.7 phr of triethylene glycol di-(2-ethylhexanoate) plasticizer. Except as provided above in this paragraph, the simulation model for EX4C-S4 was consistent with the STL model described above in Example 2. Simulated plots of STL data for EX4C-S2, EX4C-S3, and EX4C-S4 are shown in FIGS. 14 and 15.

From the STL data, it was shown that laminated glass panels formed hybrid PVAc (i.e., EX4C-S1, EX4C-S2, and EX4C-S4) in the core layers provided sound dampening improvement when compared with the laminated glass panel having a standard PVB core layer (i.e., EXC4-S3). In more detail, and with reference to FIG. 12, each of the laminated glass panels had generally equivalent sound dampening characteristics at frequencies below 4400 Hz. However, the glass panels with hybrid PVAc in the core layers (i.e., EX4C-S1 and EX4C-S2) provided an improvement over the laminated glass panel having a standard PVB core layer (i.e., EXC4-S3). FIG. 13 illustrates values of STL differences between the laminated glass panels. As shown, for frequencies above 4400 Hz, the EX4C-S1 glass panel provided an approximate improvement of between 0.6 and 1.1 dB when compared with the EX4C-S3 glass panel. The EX4C-S2 glass panel provided an approximate improvement of between 1.1 and 2.6 dB when compared with the EX4C-S3 glass panel for frequencies above 4400 Hz.

Similarly, and with reference to FIG. 14, each of the laminated glass panels had generally equivalent sound dampening characteristics at frequencies below 4400 Hz. However, the glass panels with hybrid PVAc in the core layers (i.e., EX4C-S2 and EX4C-S4) provided an improvement over the laminated glass panel having a standard PVB core layer (i.e., EXC4-S3). FIG. 15 illustrates values of STL differences between the laminated glass panels. As shown, for frequencies above 4400 Hz, the EX4C-S2 glass panel provided an approximate improvement of between 1.1 and 2.6 dB when compared with the EX4C-S3 glass panel for frequencies above 4400 Hz. The EX4C-S4 glass panel provided an approximate improvement of between 1.6 and 2.2 dB when compared with the EX4C-S3 glass panel for frequencies above 4400 Hz.

### Sub-Example 4D

A five-layer polymer interlayer, “EX4D-S1”, was formed and tested, using a DMA process described in more detail below, to determine tan δ values for the interlayer. The EX4D-S1 interlayer was formed with a core layer comprised essentially of PVAc. The core layer had a thickness of about 0.05 mm. The EX4D-S1 interlayer included a pair of skin layers positioned on either side of the core layers. The skin layers were comprised essentially of PVB and each had a thickness of about 0.10 mm. The EX4D-S1 interlayer further included a pair of bonding layers, which each bonding layer being positioned between the core layer and one of the skin layers. The bonding layers were comprised of the HRS-2 sample resin (provided above in Table 1) and were each formed to a thickness of about 0.05 mm. Each of the polymer layers of the EX4D-S1 interlayer was plasticized with poly(ethylene glycol) bis(2-ethylhexanoate).

The five-layer polymer interlayers EX4D-S1 was tested, using DMA, to determine tan δ values for the interlayer over a range of temperatures. The tan δ measurements were carried out on a sample of the interlayer that were dried in a desiccator overnight. The testing used torsional and tensile mode DMA. The samples were tested using a Rheometrics Solids Analyzer over a temperature range −20 to 60° C. at an oscillation frequency of 1 Hz. The frequency dependence parameters were derived using “time-temperature superposition,” in which the DMA was performed from 0.3 rad/s to 300 rad/s at −20° C., −10° C., 0° C., 10° C., 20° C., 30° C., 40° C., and 60° C. for each sample.

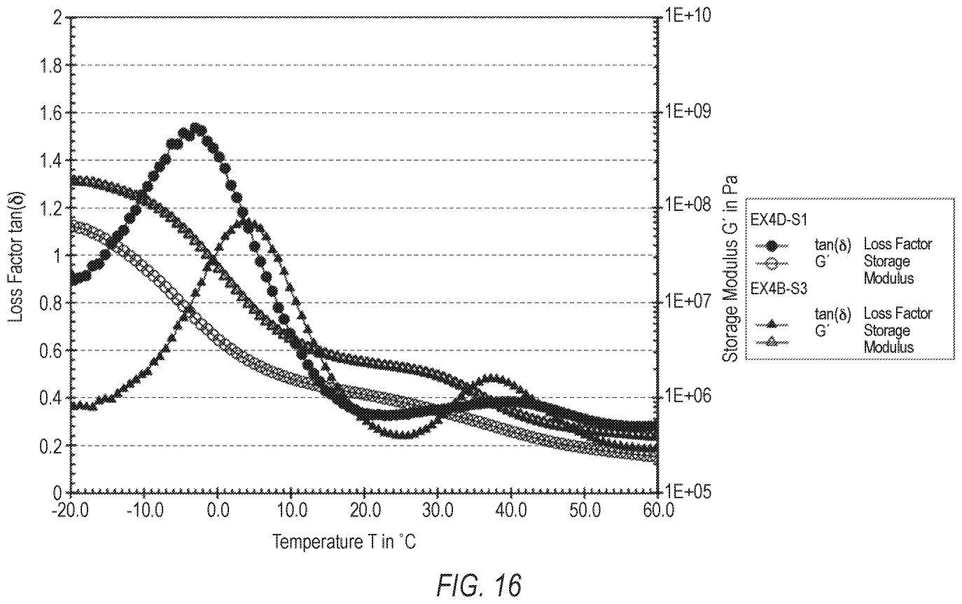

The resulting tan δ plot for each of the five-layer polymer interlayer EX4D-S1 and the above-described EX4B-S3 (standard trilayer interlayer formed essentially from PVB) are illustrated in FIG. 16. As illustrated, the five-layer interlayer EX4D-S1 yielded a peak tan δ of about 1.53 at a T_{g} of about −3° C., whereas the standard interlayer EX4B-S3 (formed with a core layer comprising standard PVB resin) yielded a peak tan δ of about 1.17 at a T_{g} of about 4° C. As such, the measured loss factor (as indicated by the tan δ values and T_{g}'s) of the interlayer formed with a five-layer interlayer (with a PVAc core layer, hybrid PVAc bonding layers, and PVB skin layers) was an improvement over the loss factor of the standard trilayer interlayer (with the core layer and skin layers comprising PVB). Specifically, the five-layer interlayer showed an increase in the peak tan δ and/or the loss factor with respect to the trilayer interlayer at the same or proximate T_{g}.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, a polymer layer can be formed comprising plasticizer content in any of the ranges given in addition to any of the ranges given for residual hydroxyl content, where appropriate, to form many permutations that are within the scope of the present invention but that would be cumbersome to list.

1. A polymer interlayer with improved acoustic properties, the polymer interlayer comprising:
a first polymer layer;
a second polymer layer; and
a third polymer layer,
wherein said first polymer layer is positioned between said second polymer layer and said third polymer layer,
wherein said first polymer layer is formed from a resin comprising polyvinyl acetate (PVAc), wherein said first polymer layer has a T_{g} of less than about 20° C. and a peak tan δ greater than about 1.5.

2. The polymer interlayer of claim 1, wherein the first polymer layer formed from a resin comprising polyvinyl acetate (PVAc) comprises:
a hybrid resin.

3. The polymer interlayer of claim 1, wherein said polymer interlayer layer has a T_{g} of less than about 20° C. and a peak tan δ greater than about 1.3.

4. The polymer interlayer of claim 1, wherein the peak tan δ of said first polymer layer is between 2.0 and 3.5.

5. The polymer interlayer of claim 2, wherein the peak tan δ of said first polymer layer is between 1.5 and 2.0.

6. The polymer interlayer of claim 1, wherein said first polymer layer has a T_{g} of between −5 and 5° C., or wherein said first polymer layer has a T_{g} of between −10 and 10° C., or wherein said first polymer layer has a T_{g} of between 0 and 10° C., or wherein said polymer interlayer has a T_{g} of less than 0° C., or wherein said polymer interlayer has a T_{g} of between 0 and 10° C.

7. The polymer interlayer of claim 1, wherein the resin of said first polymer layer comprises a glycerin based and/or an ethylene glycol diester plasticizer.

8. The polymer interlayer of claim 7, wherein the resin comprises between 50 and 70 phr of the plasticizer, or wherein the plasticizer of said first polymer layer comprises tributyrin, or wherein the plasticizer of said first polymer layer comprises a diester with four or more repeating units of ethylene glycol, or wherein the plasticizer of said first polymer layer comprises molecules with an oxygen to carbon ratio of at least 0.32, or wherein the plasticizer of said first polymer layer comprises ethylene glycol diester, and wherein the plasticizer has a molecular weight of at least 420 Daltons, or wherein the plasticizer of said first polymer layer has a total solubility parameter δₜₒₜ comprised of contributions from a dispersion solubility parameter δ_{d}, a polar solubility parameter δₚ, and a hydrogen bonding solubility parameter δₕ, wherein a ratio of contributions from the polar solubility parameter δₚ and the hydrogen bonding solubility parameter δₕ with respect to the total solubility parameter δₜₒₜ is at least 0.365.

9. The polymer interlayer of claim 1, wherein the T_{g} of said first polymer layer is less than a T_{g} of both said second polymer layer and said third polymer layers.

10. The polymer interlayer of claim 1, wherein the resin comprises from 40 to 80 wt. % acetate content, from 5 to 20 wt. % hydroxyl content, and from 20 to 40 wt. % aldehyde content.

11. The polymer interlayer of claim 1, wherein said first polymer layer consists essentially of polyvinyl acetate (PVAc).

12. The polymer interlayer of claim 1, wherein said second and third polymer layers are bonding layers that comprise a hybrid polyvinyl acetate (PVAc).

13. The polymer interlayer of claim 1, further comprising a fourth polymer layer and a fifth polymer layer, wherein said second polymer layer is positioned between said first polymer layer and said fourth polymer layer, and wherein said third polymer layer is positioned between said first polymer layer and said fifth polymer layer.

14. The polymer interlayer of claim 13, wherein said fourth and fifth polymer layers are skin layers that consist essentially of poly (vinyl butyral) (PVB).

15. A method of forming a polymer interlayer with improved acoustic properties, said method comprising the steps of:
(a) extruding a first polymer melt to form a first polymer layer; and
(b) extruding a second polymer melt to form a second polymer layer and a third polymer layer;
wherein upon said extruding of steps (a) and (b), the first polymer layer is positioned between the second and third polymer layers,
wherein the first polymer melt comprises a resin including polyvinyl acetate (PVAc), and wherein the first polymer layer has a T_{g} of less than about 20° C. and a peak tan δ greater than about 2.0.

16. The method of claim 15, wherein said extruding of steps (a) and (b) is performed via coextrusion, wherein the peak tan δ of said first polymer layer is between 2.0 and 3.5, and wherein the first polymer layer has a T_{g} of between −5 and 5° C.

17. The method of claim 15, wherein the resin includes a glycerin based and/or an ethylene glycol diester plasticizer.

18. The method of claim 15, wherein the resin comprises between 50 and 70 phr of the plasticizer, or wherein the plasticizer of said first polymer layer comprises tributyrin, or wherein the plasticizer of said first polymer layer comprises a diester with four or more repeating units of ethylene glycol, or wherein the plasticizer of said first polymer layer comprises molecules with an oxygen to carbon ratio of at least 0.32, or wherein the plasticizer of said first polymer layer comprises ethylene glycol diester, and wherein the plasticizer has a molecular weight of at least 420 Daltons, or wherein the plasticizer of said first polymer layer has a total solubility parameter δₜₒₜ comprised of contributions from a dispersion solubility parameter δ_{d}, a polar solubility parameter δₚ, and a hydrogen bonding solubility parameter δₕ, wherein a ratio of contributions from the polar solubility parameter δₚ and the hydrogen bonding solubility parameter δₕ with respect to the total solubility parameter δₜₒₜ is at least 0.365.

19. The method of claim 15, wherein the T_{g} of said first polymer layer is less than a T_{g} of both said second polymer layer and said third polymer layers.

20. The method of claim 15, wherein the resin comprises from 50 to 80 wt. % acetate content, from 5 to 20 wt. % hydroxyl content, and from 10 to 45 wt. % aldehyde content.
